(19) United States
(12) Patent Application Publication
(10) Pub. No.: US 2021/0253969 A1
(43) Pub. Date: Aug. 19, 2021

(54) LUBRICANT COMPOSITIONS FOR LUBRICATION OF A TEXTURED SURFACE AND METHODS OF USE THEREOF

(71) Applicant: ADAPTIVE SURFACE TECHNOLOGIES, INC., Cambridge, MA (US)

(72) Inventors: Gurminder Kaur PAINK, Cambridge, MA (US); Grant William TREMELLING, Cambridge, MA (US); Tehila NAHUM, Cambridge, MA (US); Philseok KIM, Cambridge, MA (US)

(21) Appl. No.: 17/272,104

(22) PCT Filed: Aug. 31, 2019
(86) PCT No.: PCT/US2019/049246

§ 371 Date: Feb. 26, 2021

Related U.S. Application Data
(60) Provisional application No. 62/725,687, filed on Aug. 31, 2018.

(51) Int. Cl. C10M 107/38; B05D 1/02; B05D 5/08; C09D 127/18

(52) U.S. Cl. CPC C10M 107/38; B05D 1/02; B05D 5/083; B05D 2401/21; C10M 2213/0623; C10M 2207/021; B05D 2401/10; C09D 127/18

(57) ABSTRACT

Lubricant compositions and methods of applying lubricant compositions are provided that overcome problems associated with over-lubrication and waste of lubricants in a variety of industrial settings. In various aspects, a lubricant composition is provided with one or more carriers, wherein the surface tensions of the lubricant and carrier are selected to provide precise lubrication of a surface with the lubricant effectively wetting the surface. In various aspects, a lubricant composition is provided with one or more carriers, wherein the boiling points of the lubricant and carrier are selected to provide precise lubrication with easy removal of the carrier and wetting of the lubricant on the surface. In various aspects, methods of applying a precise amount of lubricant to a surface are provided to avoid waste of lubricant in various industrial settings.

### CROSS-REFERENCE TO RELATED APPLICATIONS

This application claims priority to, and the benefit of, co-pending U.S. provisional application entitled “LUBRICANT COMPOSITIONS FOR LUBRICATION OF A TEXTURED SURFACE AND METHODS OF USE THEREOF” having Ser. No. 62/725,687, filed Aug. 31, 2018 (Attorney Docket No. 921904-8080), the contents of which are incorporated by reference in their entirety.

### TECHNICAL FIELD

The present disclosure generally relates to lubricant compositions for coatings and surfaces, and in particular to create coatings and surfaces that are slippery and/or non-stick.

### SUMMARY

In various aspects, this disclosure is directed to coatings and surfaces, methods and compositions for making coatings on surfaces, coated surfaces and articles, and uses thereof. In particular aspects, the disclosure is directed to lubricant compositions (coating compositions) and methods of precisely applying lubricant using the coating compositions to create coatings on surfaces, coated surfaces and articles, and uses thereof. Precise application of lubricants eliminates over-lubrication and waste of lubricants in a variety of industrial settings. Over-lubrication is a common problem with many conventional methods of applying lubricant to a surface, and this leads to costly waste as excess lubricant is often not recovered in a manner allowing for reuse. Improved lubricant compositions and methods of applying lubricant compositions are needed. In some aspects, the surfaces are capable of supporting a stable liquid-infused porous surface, creating a slippery lubricating surface that can repel objects to be repelled from the surface. The surfaces can be essentially free of pinning points leading to improved performance, low contact angle hysteresis on the surface, and improved surface lifetime.

In some aspects, a lubricant composition is provided for lubrication of a hydrophobic textured solid surface, the composition having a first effective amount of a low surface tension liquid, wherein the low surface tension liquid has a positive spreading coefficient to the solid surface and a chemical affinity for the hydrophobic textured surface and a surface tension (mN/m) that is lower than a surface energy (mJ/m2) of the hydrophobic textured surface, and wherein the first effective amount is such that the low surface tension liquid spontaneously wets, spreads, and adheres to the hydrophobic textured surface when applied thereto to lubricate the hydrophobic textured solid surface; and a second effective amount of a high surface tension liquid, wherein the high surface tension liquid is immiscible with the low surface tension liquid and is non-reactive with the low surface tension liquid, wherein the high surface tension liquid preferentially dewets the hydrophobic textured surface and has a negative spreading coefficient to the solid surface and has a surface tension (mN/m) that is higher than the surface energy value (mJ/m2) of the hydrophobic textured surface, and wherein the second effective amount is effective to support an emulsion of the low surface tension liquid dispersed within the high surface tension liquid. In some aspects, the composition includes more than one high surface tension liquid, e.g. 2, 3, or more high surface tension liquids can be combined to form the carrier so long as each of the high surface tension liquids dewets the surface and have a surface tension (mN/m) that is higher than the surface energy value (mJ/m2) of the hydrophobic textured surface, and wherein the total amount of high surface tension liquids is effective to support an emulsion of the low surface tension liquid dispersed within the high surface tension liquids.

In some aspects, a multiphase lubricant composition is provided for lubrication of a hydrophobic textured solid surface, the composition having a first effective amount of a high boiling liquid, wherein the high boiling liquid has a positive spreading coefficient to the solid surface and a chemical affinity for the hydrophobic textured surface, and wherein the first effective amount is such that the high boiling liquid spontaneously wets and adheres to the hydrophobic textured surface when applied thereto to lubricate the hydrophobic textured surface; and a second effective amount of a low boiling liquid preferentially having a positive spreading coefficient to the solid surface and chemical affinity and completely wetting to the textured surface, wherein the high boiling liquid is immiscible with and unreactive with the low boiling liquid, and wherein the second effective amount is effective to support an emulsion of the high boiling liquid dispersed within the low boiling liquid. In some aspects, the composition includes two or more low boiling liquids, e.g. 2, 3, or more low boiling liquids can be combined to form the carrier so long as the high boiling liquid is immiscible and unreactive with each of the low boiling liquids, preferentially where each of the low boiling liquids have a positive spreading coefficient to the solid surface and chemical affinity and completely wetting to the surface.

In some aspects, a lubricant composition is provided for lubrication of a hydrophobic textured solid surface, the composition having a first effective amount of a high boiling liquid, wherein the high boiling liquid has a positive spreading coefficient to the solid surface and a chemical affinity for the hydrophobic textured surface, and wherein the first effective amount is such that the high boiling liquid spontaneously wets and adheres to the hydrophobic textured surface when applied thereto to lubricate the hydrophobic textured surface; and a low boiling liquid preferentially having a positive spreading coefficient to the solid surface and chemical affinity and completely wetting to the textured surface, wherein the high boiling liquid is miscible with and unreactive with the low boiling liquid. In some aspects, the composition includes two or more low boiling liquids, e.g. 2, 3, or more low boiling liquids can be combined to form the carrier so long as the high boiling liquid is miscible and unreactive with the low boiling liquids, preferentially where each of the low boiling liquids have a positive spreading coefficient to the solid surface and chemical affinity and completely wetting to the surface.

In various aspects, methods of precisely applying lubricant to a surface are provided using one of the lubricant compositions provided herein. The methods can include transferring a lubricating liquid composition substantially free of particulate matter onto a textured solid surface from an immiscible lubricating liquid composition in which each component has different signs of spreading coefficient to the solid surface and different surface tension values, where a preferentially wetting liquid component is deposited to the textured surface, while a preferentially non-wetting liquid component is removed. The methods can include transferring a lubricating liquid composition substantially free of particulate matter onto a textured solid surface from an immiscible lubricating liquid composition in which both components have a positive spreading coefficient to the solid surface but each component has different boiling points, where a high boiling liquid component is deposited to the textured surface, while a low boiling liquid component is removed by heating or over time at ambient condition. The methods can include transferring a lubricating liquid composition substantially free of particulate matter onto a textured solid surface from a miscible lubricating liquid composition in which both components have a positive spreading coefficient to the solid surface but each component has different boiling points, where a high boiling liquid component is deposited to the textured surface, while a low boiling liquid component is removed by heating or over time at ambient condition.

Other systems, methods, features, and advantages of the lubricant and coating compositions, coatings, surfaces, methods, compositions, articles, and uses thereof will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Further aspects of the present disclosure will be readily appreciated upon review of the detailed description of its various embodiments, described below, when taken in conjunction with the accompanying drawings.

FIGS. 1A-1D are keyence microscope images of the textured surface as a function of transferred lubricant mass to the textured surface by increasing number of application passes. (FIG. 1A) 1.1 mg (FIG. 1B) 1.8 mg (FIG. 1C) 2.2 mg (FIG. 1D) 2.8 mg.

FIGS. 2A-2E are keyence microscope images of the textured surface as a function of net transferred lubricant mass by increasing number of application passes. (FIG. 2A) 1.1 mg (FIG. 2B) 1.5 mg (FIG. 2C) 1.9 mg (FIG. 2D) 2.2 mg (FIG. 2E) 3.1 mg.

FIGS. 3A-3D are keyence microscope images of the textured surface as a function of transferred lubricant mass by increasing number of application passes. (FIG. 3A) 1.2 mg (FIG. 3B) 2.3 mg (FIG. 3C) 3.4 mg (FIG. 3D) 4.1 mg.

FIGS. 4A-4D are keyence microscope images of the texture surface as a function of transferred lubricant mass resulting from varying concentrations of Krytox lubricant ('active) in water (“carrier”) at same number of application passes. (FIG. 4A) 0.5 mg (FIG. 4B) 2.5 mg (FIG. 4C) 4.5 mg (FIG. 4D) 13.3 mg.

FIGS. 5A-5D are keyence microscope images of the texture surface as a function of net transferred lubricant mass resulting from varying concentrations of Krytox lubricant ('active) in HFE-7000 (‘carrier’) at same number of application passes. (FIG. 5A) 1.1 mg (FIG. 5B) 2.2 mg (FIG. 5C) 3.4 mg (FIG. 5D) 21.0 mg.

FIGS. 6A-6D are keyence microscope images of the texture surface as function of net transferred lubricant mass resulting from varying concentrations of Krytox lubricant (‘active’) in ethanol (“carrier”) at same number of application passes. (FIG. 6A) 1.4 mg (FIG. 6B) 3.9 mg (FIG. 6C) 8.9 mg (FIG. 6D) 30.0 mg.

FIG. 7 is a schematic of (left) a tank coated with hydrophobic texture and (right) a pressure washing device used to apply liquid with the carrier solvent.

FIG. 8 is a series of images of a coated tank after the application of the liquid, where the tank was partially filled with a viscous solvent free polymer and the end of the drainage was observed visually.

FIG. 9 is an image of a series of emulsions with varying concentration of Novec hydrofluoroether (HFE -7100) in Krytox (GPL 105) with increasing ratio of HFE -7100 to K105 moving from left to right (ratios are given below each image). Higher concentration of Novec hydrofluoroether (HFE -7100) results in haziness indicating improved dispersion of droplets.

FIG. 10 is a series of images of glass slides after spray lubrication with varying concentrations of Novec hydrofluoroether (HFE -7100) in Krytox (GPL 105). The ratios include (from left to right) 0 g, 0.5 g, 1 g, 3 g, and 5 g of HFE -7100 in 200 mg K105. Clear slides showcase better transfer efficiencies and leveling of lubricant.

FIGS. 11A-11D are images of (FIGS. 11A-11B) Krytox 107 being injected at a controlled rate using a venturi valve and applied to a textured hydrophobic coating inside a 5 gallon hopper using a clean in place system with water as a carrier solvent and (FIGS. 11C-11B) the water de-wetting and quickly sliding away from areas where the lubricant is deposited. The change in gloss is used to determine full coverage of lubricant as outlined in the white boxes.

FIGS. 12A-12B are a series of images as Krytox 107 is injected at a controlled rate using a venturi valve fitted to an industrial water pressure washer and is applied to stainless steel panels coated with a textured hydrophobic coating. Nozzle pressures of (FIG. 12A) 100 bar and (FIG. 12B) 150 bar are tested. Once the panels show de-wetting of water from the surface the application is stopped as the minimal functional amount required is applied.

FIG. 13 is a bar graph of the amount of lubricant deposited at 100 bar (left) and 150 bar (right) demonstrating that the target amount of lubricant required in FIG. 12 is accurately achieved using high pressure application of lubricant using a pressure washer

FIG. 14 is a bar graph of the relative transfer efficiency (%) at various liquid concentrations, pressures, and distances demonstrating that lower injection rates result in higher transfer efficiency. At low pressures the transfer efficiency is similar. The transfer efficiency increases as the distance to the surface decreases.

FIG. 15 is a bar graph of the relative transfer efficiency of K105 lubricant without (left) and with HFE 7100 carrier solvent demonstrating that using an additional carrier solvent improves the transfer efficiency.

FIG. 16 is a graph of the lubricant mass for various lubricants applied to a substrate and subjected to high shear with a spin coater as a function of the speed of the spin coater (RPM), showing that the target mass for the lubricant can be determined by applying high shear to the lubricant using a spin coater.

FIGS. 17A-17B are bar graphs of deposition of lubricant (lubricant mass in mg) per spray pass onto the surface (FIG. 17A) and the total amount of lubricant deposited onto the surface (FIG. 17B) for coating compositions listed in Table .

FIGS. 18A-18F are optical images of lubricated glass slides with different emulsion mixtures and methods. Lubrication uniformity of (FIGS. 18C-18D) emulsion spray is similar to uniformity achieved by spin coating glass slides (FIG. 18E) at 10k rpm for 1 min. FIG. 18A and FIG. 18B images showcase over lubrication as seen by the sagging on the surface. FIGS. 18A-18E all exhibit full transparency as compared to the unlubricated slide (FIG. 18F).

FIG. 19 is a bar graph of the lubricant transfer assuming a 4000 gal vessel with H/D=8000 containing a batch size of 10,800 kg at any given time, the lubricant transfer per cycle is calculated based on the solutions presented in Table 18. The lubricant depletion rate is assumed to be between 1-5%. For Solutions A-B, the contamination level can be almost 2 orders of magnitude greater than solutions D-E.

### DETAILED DESCRIPTION

Precise application of lubricants eliminates over-lubrication and waste of lubricants in a variety of industrial settings. Over-lubrication is a common problem with many conventional methods of applying lubricant to a surface, and this leads to costly waste as excess lubricant is often not recovered in a manner allowing for reuse. Improved lubricant compositions and methods of applying lubricant compositions are needed.

Before the present disclosure is described in greater detail, it is to be understood that this disclosure is not limited to particular embodiments described, and as such may, of course, vary. It is also to be understood that the terminology used herein is for the purpose of describing particular embodiments only, and is not intended to be limiting. The skilled artisan will recognize many variants and adaptations of the embodiments described herein. These variants and adaptations are intended to be included in the teachings of this disclosure and to be encompassed by the claims herein.

All publications and patents cited in this specification are cited to disclose and describe the methods and/or materials in connection with which the publications are cited. All such publications and patents are herein incorporated by references as if each individual publication or patent were specifically and individually indicated to be incorporated by reference. Such incorporation by reference is expressly limited to the methods and/or materials described in the cited publications and patents and does not extend to any lexicographical definitions from the cited publications and patents. Any lexicographical definition in the publications and patents cited that is not also expressly repeated in the instant specification should not be treated as such and should not be read as defining any terms appearing in the accompanying claims. The citation of any publication is for its disclosure prior to the filing date and should not be construed as an admission that the present disclosure is not entitled to antedate such publication by virtue of prior disclosure. Further, the dates of publication provided could be different from the actual publication dates that may need to be independently confirmed.

Although any methods and materials similar or equivalent to those described herein can also be used in the practice or testing of the present disclosure, the preferred methods and materials are now described. Functions or constructions well-known in the art may not be described in detail for brevity and/or clarity. Embodiments of the present disclosure will employ, unless otherwise indicated, techniques of nanotechnology, organic chemistry, material science and engineering and the like, which are within the skill of the art. Such techniques are explained fully in the literature.

It should be noted that ratios, concentrations, amounts, and other numerical data can be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “about 0.1% to about 5%” should be interpreted to include not only the explicitly recited values of about 0.1% to about 5%, but also include individual values (e.g., 1%, 2%, 3%, and 4%) and the sub-ranges (e.g., 0.5%, 1.1%, 2.2%, 3.3%, and 4.4%) within the indicated range. Where the stated range includes one or both of the limits, ranges excluding either or both of those included limits are also included in the disclosure, e.g. the phrase “x to y” includes the range from ‘x’ to ‘y’ as well as the range greater than ‘x’ and less than ‘y’. The range can also be expressed as an upper limit, e.g. ‘about x, y, z, or less’ and should be interpreted to include the specific ranges of ‘about x’, ‘about y’, and ‘about z’ as well as the ranges of ‘less than x’, ‘less than y’, and ‘less than z’. Likewise, the phrase ‘about x, y, z, or greater’ should be interpreted to include the specific ranges of ‘about x’, ‘about y’, and ‘about z’ as well as the ranges of ‘greater than x’, ‘greater than y’, and ‘greater than z’. In some embodiments, the term “about” can include traditional rounding according to significant figures of the numerical value. In addition, the phrase “about ‘x’ to ‘y’”, where ‘x’ and ‘y’ are numerical values, includes “about ‘x’ to about ‘y’”.

Definitions

Unless defined otherwise, all technical and scientific terms used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the specification and relevant art and should not be interpreted in an idealized or overly formal sense unless expressly defined herein.

The articles “a” and “an,” as used herein, mean one or more when applied to any feature in embodiments of the present invention described in the specification and claims. The use of “a” and “an” does not limit the meaning to a single feature unless such a limit is specifically stated. The article “the” preceding singular or plural nouns or noun phrases denotes a particular specified feature or particular specified features and may have a singular or plural connotation depending upon the context in which it is used.

Throughout the application, where language such as having, including, or comprising is used to describe specific components or process steps, it is contemplated that other aspects exist that consist essentially of, or consist of the specific components or process steps.

The term “substantially free” as used in this context means the reaction product and/or coating compositions contain less than 1000 parts per million (ppm),“essentially free” means less than 100 ppm and “completely free” means less than 20 parts per billion (ppb) of any of the above compounds or derivatives or residues thereof. The term “about,” as used herein, means approximately, in the region of, roughly, or around. When the term “about” is used with a numerical value, it modifies that value by extending the boundaries above and below the numerical value set forth. For example, in some aspects, the term “about” is used herein to modify a numerical value above and below the stated value by a variance of ±20%, ±15%, or ±10% of the stated value. In some aspects, the term “about” can reflect traditional uncertainties in experimental measurements and/or traditional rounding according to significant figures of the numerical value.

The term “alkyl” refers to the radical of saturated aliphatic groups, including straight-chain alkyl groups, branched-chain alkyl groups, cycloalkyl (alicyclic) groups, alkyl-substituted cycloalkyl groups, and cycloalkyl-substituted alkyl groups.

In some aspects, a straight chain or branched chain alkyl has 30 or fewer carbon atoms in its backbone (e.g., C₁-C₃₀ for straight chains, C₃-C₃₀ for branched chains), 20 or fewer, 12 or fewer, or 7 or fewer. Likewise, in some embodiments cycloalkyls have from 3-10 carbon atoms in their ring structure, e.g. have 5, 6 or 7 carbons in the ring structure. The term “alkyl” (or “lower alkyl”) as used throughout the specification, examples, and claims is intended to include both “unsubstituted alkyls” and “substituted alkyls”, the latter of which refers to alkyl moieties having one or more substituents replacing a hydrogen on one or more carbons of the hydrocarbon backbone. Such substituents include, but are not limited to, halogen, hydroxyl, carbonyl (such as a carboxyl, alkoxycarbonyl, formyl, or an acyl), thiocarbonyl (such as a thioester, a thioacetate, or a thioformate), alkoxyl, phosphoryl, phosphate, phosphonate, a hosphinate, amino, amido, amidine, imine, cyano, nitro, azido, sulfhydryl, alkylthio, sulfate, sulfonate, sulfamoyl, sulfonamido, sulfonyl, heterocyclyl, aralkyl, or an aromatic or heteroaromatic moiety.

Unless the number of carbons is otherwise specified, “lower alkyl” as used herein means an alkyl group, as defined above, but having from one to ten carbons, or from one to six carbon atoms in its backbone structure. Likewise, “lower alkenyl” and “lower alkynyl” have similar chain lengths. Throughout the application, preferred alkyl groups are lower alkyls. In some embodiments, a substituent designated herein as alkyl is a lower alkyl.

It will be understood by those skilled in the art that the moieties substituted on the hydrocarbon chain can themselves be substituted, if appropriate. For instance, the substituents of a substituted alkyl may include halogen, hydroxy, nitro, thiols, amino, azido, imino, amido, phosphoryl (including phosphonate and phosphinate), sulfonyl (including sulfate, sulfonamido, sulfamoyl and sulfonate), and silyl groups, as well as ethers, alkylthios, carbonyls (including ketones, aldehydes, carboxylates, and esters), —CF₃, —CN and the like. Cycloalkyls can be substituted in the same manner.

The term “heteroalkyl”, as used herein, refers to straight or branched chain, or cyclic carbon-containing radicals, or combinations thereof, containing at least one heteroatom. Suitable heteroatoms include, but are not limited to, O, N, Si, P, Se, B, and S, wherein the phosphorous and sulfur atoms are optionally oxidized, and the nitrogen heteroatom is optionally quaternized. Heteroalkyls can be substituted as defined above for alkyl groups.

The term “alkylthio” refers to an alkyl group, as defined above, having a sulfur radical attached thereto. In some embodiments, the “alkylthio” moiety is represented by one of —S-alkyl, —S-alkenyl, and —S-alkynyl. Representative alkylthio groups include methylthio, and ethylthio. The term “alkylthio” also encompasses cycloalkyl groups, alkene and cycloalkene groups, and alkyne groups. “Arylthio” refers to aryl or heteroaryl groups. Alkylthio groups can be substituted as defined above for alkyl groups.

The terms “alkenyl” and “alkynyl”, refer to unsaturated aliphatic groups analogous in length and possible substitution to the alkyls described above, but that contain at least one double or triple bond respectively.

The terms “alkoxyl” or “alkoxy” as used herein refers to an alkyl group, as defined above, having an oxygen radical attached thereto. Representative alkoxyl groups include methoxy, ethoxy, propyloxy, and tert-butoxy. An “ether” is two hydrocarbons covalently linked by an oxygen. Accordingly, the substituent of an alkyl that renders that alkyl an ether is or resembles an alkoxyl, such as can be represented by one of —O-alkyl, —O-alkenyl, and —O-alkynyl. Aroxy can be represented by —O-aryl or O-heteroaryl, wherein aryl and heteroaryl are as defined below. The alkoxy and aroxy groups can be substituted as described above for alkyl.

The terms “amine” and “amino” are art-recognized and refer to both unsubstituted and substituted amines, e.g., a moiety that can be represented by the general formula:

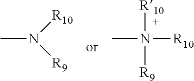

wherein R₉, R₁₀, and R′₁₀ each independently represent a hydrogen, an alkyl, an alkenyl, —(CH₂)ₘ—R₈ or R₉ and R₁₀ taken together with the N atom to which they are attached complete a heterocycle having from 4 to 8 atoms in the ring structure; R₈ represents an aryl, a cycloalkyl, a cycloalkenyl, a heterocycle or a polycycle; and m is zero or an integer in the range of 1 to 8. In some embodiments, only one of R₉ or R₁₀ can be a carbonyl, e.g., R₉, R₁₀ and the nitrogen together do not form an imide. In still other embodiments, the term “amine” does not encompass amides, e.g., wherein one of R₉ and R₁₀ represents a carbonyl. In additional embodiments, R₉ and R₁₀ (and optionally R′₁₀) each independently represent a hydrogen, an alkyl or cycloakly, an alkenyl or cycloalkenyl, or alkynyl. Thus, the term “alkylamine” as used herein means an amine group, as defined above, having a substituted (as described above for alkyl) or unsubstituted alkyl attached thereto, i.e., at least one of R₉ and R₁₀ is an alkyl group.

The term “amido” is art-recognized as an amino-substituted carbonyl and includes a moiety that can be represented by the general formula:

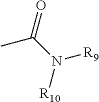

wherein R₉ and R₁₀ are as defined above.

“Aryl”, as used herein, refers to C₅-C₁₀-membered aromatic, heterocyclic, fused aromatic, fused heterocyclic, biaromatic, or bihetereocyclic ring systems. Broadly defined, “aryl”, as used herein, includes 5-, 6-, 7-, 8-, 9-, and 10-membered single-ring aromatic groups that may include from zero to four heteroatoms, for example, benzene, pyrrole, furan, thiophene, imidazole, oxazole, thiazole, triazole, pyrazole, pyridine, pyrazine, pyridazine and pyrimidine, and the like. Those aryl groups having heteroatoms in the ring structure may also be referred to as “aryl heterocycles” or “heteroaromatics”. The aromatic ring can be substituted at one or more ring positions with one or more substituents including, but not limited to, halogen, azide, alkyl, aralkyl, alkenyl, alkynyl, cycloalkyl, hydroxyl, alkoxyl, amino (or quaternized amino), nitro, sulfhydryl, imino, amido, phosphonate, phosphinate, carbonyl, carboxyl, silyl, ether, alkylthio, sulfonyl, sulfonamido, ketone, aldehyde, ester, heterocyclyl, aromatic or heteroaromatic moieties, —CF₃, —CN; and combinations thereof.

The term “aryl” also includes polycyclic ring systems having two or more cyclic rings in which two or more carbons are common to two adjoining rings (i.e., “fused rings”) wherein at least one of the rings is aromatic, e.g., the other cyclic ring or rings can be cycloalkyls, cycloalkenyls, cycloalkynyls, aryls and/or heterocycles. Examples of heterocyclic rings include, but are not limited to, benzimidazolyl, benzofuranyl, benzothiofuranyl, benzothiophenyl, benzoxazolyl, benzoxazolinyl, benzthiazolyl, benztriazolyl, benztetrazolyl, benzisoxazolyl, benzisothiazolyl, benzimidazolinyl, carbazolyl, 4aH carbazolyl, carbolinyl, chromanyl, chromenyl, cinnolinyl, decahydroquinolinyl, 2H,6H-1,5,2-dithiazinyl, dihydrofuro[2,3 b]tetrahydrofuran, furanyl, furazanyl, imidazolidinyl, imidazolinyl, imidazolyl, 1H-indazolyl, indolenyl, indolinyl, indolizinyl, indolyl, 3H-indolyl, isatinoyl, isobenzofuranyl, isochromanyl, isoindazolyl, isoindolinyl, isoindolyl, isoquinolinyl, isothiazolyl, isoxazolyl, methylenedioxyphenyl, morpholinyl, naphthyridinyl, octahydroisoquinolinyl, oxadiazolyl, 1,2,3-oxadiazolyl, 1,2,4-oxadiazolyl, 1,2,5-oxadiazolyl, 1,3,4-oxadiazolyl, oxazolidinyl, oxazolyl, oxindolyl, pyrimidinyl, phenanthridinyl, phenanthrolinyl, phenazinyl, phenothiazinyl, phenoxathinyl, phenoxazinyl, phthalazinyl, piperazinyl, piperidinyl, piperidonyl, 4-piperidonyl, piperonyl, pteridinyl, purinyl, pyranyl, pyrazinyl, pyrazolidinyl, pyrazolinyl, pyrazolyl, pyridazinyl, pyridooxazole, pyridoimidazole, pyridothiazole, pyridinyl, pyridyl, pyrimidinyl, pyrrolidinyl, pyrrolinyl, 2H-pyrrolyl, pyrrolyl, quinazolinyl, quinolinyl, 4H-quinolizinyl, quinoxalinyl, quinuclidinyl, tetrahydrofuranyl, tetrahydroisoquinolinyl, tetrahydroquinolinyl, tetrazolyl, 6H-1,2,5-thiadiazinyl, 1,2,3-thiadiazolyl, 1,2,4-thiadiazolyl, 1,2,5-thiadiazolyl, 1,3,4-thiadiazolyl, thianthrenyl, thiazolyl, thienyl, thienothiazolyl, thienooxazolyl, thienoimidazolyl, thiophenyl and xanthenyl. One or more of the rings can be substituted as defined above for “aryl”.

The term “aralkyl”, as used herein, refers to an alkyl group substituted with an aryl group (e.g., an aromatic or heteroaromatic group).

The term “carbocycle”, as used herein, refers to an aromatic or non-aromatic ring in which each atom of the ring is carbon.

“Heterocycle” or “heterocyclic”, as used herein, refers to a cyclic radical attached via a ring carbon or nitrogen of a monocyclic or bicyclic ring containing 3-10 ring atoms, and preferably from 5-6 ring atoms, consisting of carbon and one to four heteroatoms each selected from the group consisting of non-peroxide oxygen, sulfur, and N(Y) wherein Y is absent or is H, O, (C₁-C₁₀) alkyl, phenyl or benzyl, and optionally containing 1-3 double bonds and optionally substituted with one or more substituents. Examples of heterocyclic ring include, but are not limited to, benzimidazolyl, benzofuranyl, benzothiofuranyl, benzothiophenyl, benzoxazolyl, benzoxazolinyl, benzthiazolyl, benztriazolyl, benztetrazolyl, benzisoxazolyl, benzisothiazolyl, benzimidazolinyl, carbazolyl, 4aH-carbazolyl, carbolinyl, chromanyl, chromenyl, cinnolinyl, decahydroquinolinyl, 2H,6H-1,5,2-dithiazinyl, dihydrofuro[2,3-b]tetrahydrofuran, furanyl, furazanyl, imidazolidinyl, imidazolinyl, imidazolyl, 1H-indazolyl, indolenyl, indolinyl, indolizinyl, indolyl, 3H-indolyl, isatinoyl, isobenzofuranyl, isochromanyl, isoindazolyl, isoindolinyl, isoindolyl, isoquinolinyl, isothiazolyl, isoxazolyl, methylenedioxyphenyl, morpholinyl, naphthyridinyl, octahydroisoquinolinyl, oxadiazolyl, 1,2,3-oxadiazolyl, 1,2,4-oxadiazolyl, 1,2,5-oxadiazolyl, 1,3,4-oxadiazolyl, oxazolidinyl, oxazolyl, oxepanyl, oxetanyl, oxindolyl, pyrimidinyl, phenanthridinyl, phenanthrolinyl, phenazinyl, phenothiazinyl, phenoxathinyl, phenoxazinyl, phthalazinyl, piperazinyl, piperidinyl, piperidonyl, 4-piperidonyl, piperonyl, pteridinyl, purinyl, pyranyl, pyrazinyl, pyrazolidinyl, pyrazolinyl, pyrazolyl, pyridazinyl, pyridooxazole, pyridoimidazole, pyridothiazole, pyridinyl, pyridyl, pyrimidinyl, pyrrolidinyl, pyrrolinyl, 2H-pyrrolyl, pyrrolyl, quinazolinyl, quinolinyl, 4H-quinolizinyl, quinoxalinyl, quinuclidinyl, tetrahydrofuranyl, tetrahydroisoquinolinyl, tetrahydropyranyl, tetrahydroquinolinyl, tetrazolyl, 6H-1,2,5-thiadiazinyl, 1,2,3-thiadiazolyl, 1,2,4-thiadiazolyl, 1,2,5-thiadiazolyl, 1,3,4-thiadiazolyl, thianthrenyl, thiazolyl, thienyl, thienothiazolyl, thienooxazolyl, thienoimidazolyl, thiophenyl and xanthenyl. Heterocyclic groups can optionally be substituted with one or more substituents at one or more positions as defined above for alkyl and aryl, for example, halogen, alkyl, aralkyl, alkenyl, alkynyl, cycloalkyl, hydroxyl, amino, nitro, sulfhydryl, imino, amido, phosphate, phosphonate, phosphinate, carbonyl, carboxyl, silyl, ether, alkylthio, sulfonyl, ketone, aldehyde, ester, a heterocyclyl, an aromatic or heteroaromatic moiety, —CF3, and —CN.

The term “carbonyl” is art-recognized and includes such moieties as can be represented by the general formula:

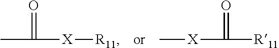

wherein X is a bond or represents an oxygen or a sulfur, and R₁₁ represents a hydrogen, an alkyl, a cycloalkyl, an alkenyl, an cycloalkenyl, or an alkynyl, R′₁₁ represents a hydrogen, an alkyl, a cycloalkyl, an alkenyl, an cycloalkenyl, or an alkynyl. Where X is an oxygen and R₁₁ or R′₁₁ is not hydrogen, the formula represents an “ester”. Where X is an oxygen and R₁₁ is as defined above, the moiety is referred to herein as a carboxyl group, and particularly when R₁₁ is a hydrogen, the formula represents a “carboxylic acid”. Where X is an oxygen and R′₁₁ is hydrogen, the formula represents a “formate”. In general, where the oxygen atom of the above formula is replaced by sulfur, the formula represents a “thiocarbonyl” group. Where X is a sulfur and R₁₁ or R′11 is not hydrogen, the formula represents a “thioester.” Where X is a sulfur and R₁₁ is hydrogen, the formula represents a “thiocarboxylic acid.” Where X is a sulfur and R′₁₁ is hydrogen, the formula represents a “thioformate.” On the other hand, where X is a bond, and R₁₁ is not hydrogen, the above formula represents a “ketone” group. Where X is a bond, and R₁₁ is hydrogen, the above formula represents an “aldehyde” group.

The term “monoester” as used herein refers to an analogue of a dicarboxylic acid wherein one of the carboxylic acids is functionalized as an ester and the other carboxylic acid is a free carboxylic acid or salt of a carboxylic acid. Examples of monoesters include, but are not limited to, to monoesters of succinic acid, glutaric acid, adipic acid, suberic acid, sebacic acid, azelaic acid, oxalic and maleic acid.

The term “heteroatom” as used herein means an atom of any element other than carbon or hydrogen. Examples of heteroatoms are boron, nitrogen, oxygen, phosphorus, sulfur and selenium. Other heteroatoms include silicon and arsenic.

As used herein, the term “nitro” means —NO₂; the term “halogen” designates —F, —Cl, —Br or —I; the term “sulfhydryl” means —SH; the term “hydroxyl” means —OH; and the term “sulfonyl” means —SO₂—.

The term “substituted” as used herein, refers to all permissible substituents of the compounds described herein. In the broadest sense, the permissible substituents include acyclic and cyclic, branched and unbranched, carbocyclic and heterocyclic, aromatic and nonaromatic substituents of organic compounds. Illustrative substituents include, but are not limited to, halogens, hydroxyl groups, or any other organic groupings containing any number of carbon atoms, preferably 1-14 carbon atoms, and optionally include one or more heteroatoms such as oxygen, sulfur, or nitrogen grouping in linear, branched, or cyclic structural formats. Representative substituents include alkyl, substituted alkyl, alkenyl, substituted alkenyl, alkynyl, substituted alkynyl, phenyl, substituted phenyl, aryl, substituted aryl, heteroaryl, substituted heteroaryl, halo, hydroxyl, alkoxy, substituted alkoxy, phenoxy, substituted phenoxy, aroxy, substituted aroxy, alkylthio, substituted alkylthio, phenylthio, substituted phenylthio, arylthio, substituted arylthio, cyano, isocyano, substituted isocyano, carbonyl, substituted carbonyl, carboxyl, substituted carboxyl, amino, substituted amino, amido, substituted amido, sulfonyl, substituted sulfonyl, sulfonic acid, phosphoryl, substituted phosphoryl, phosphonyl, substituted phosphonyl, polyaryl, substituted polyaryl, C₃-C₂₀ cyclic, substituted C₃-C₂₀ cyclic, heterocyclic, substituted heterocyclic, aminoacid, peptide, and polypeptide groups.

Heteroatoms such as nitrogen may have hydrogen substituents and/or any permissible substituents of organic compounds described herein which satisfy the valences of the heteroatoms. It is understood that “substitution” or “substituted” includes the implicit proviso that such substitution is in accordance with permitted valence of the substituted atom and the substituent, and that the substitution results in a stable compound, i.e. a compound that does not spontaneously undergo transformation such as by rearrangement, cyclization, elimination, etc.

In a broad aspect, the permissible substituents include acyclic and cyclic, branched and unbranched, carbocyclic and heterocyclic, aromatic and nonaromatic substituents of organic compounds. Illustrative substituents include, for example, those described herein. The permissible substituents can be one or more and the same or different for appropriate organic compounds. The heteroatoms such as nitrogen may have hydrogen substituents and/or any permissible substituents of organic compounds described herein which satisfy the valencies of the heteroatoms.

In various embodiments, the substituent is selected from alkoxy, aryloxy, alkyl, alkenyl, alkynyl, amide, amino, aryl, arylalkyl, carbamate, carboxy, cyano, cycloalkyl, ester, ether, formyl, halogen, haloalkyl, heteroaryl, heterocyclyl, hydroxyl, ketone, nitro, phosphate, sulfide, sulfinyl, sulfonyl, sulfonic acid, sulfonamide, and thioketone, each of which optionally is substituted with one or more suitable substituents. In some embodiments, the substituent is selected from alkoxy, aryloxy, alkyl, alkenyl, alkynyl, amide, amino, aryl, arylalkyl, carbamate, carboxy, cycloalkyl, ester, ether, formyl, haloalkyl, heteroaryl, heterocyclyl, ketone, phosphate, sulfide, sulfinyl, sulfonyl, sulfonic acid, sulfonamide, and thioketone, wherein each of the alkoxy, aryloxy, alkyl, alkenyl, alkynyl, amide, amino, aryl, arylalkyl, carbamate, carboxy, cycloalkyl, ester, ether, formyl, haloalkyl, heteroaryl, heterocyclyl, ketone, phosphate, sulfide, sulfinyl, sulfonyl, sulfonic acid, sulfonamide, and thioketone can be further substituted with one or more suitable substituents.

Examples of substituents include, but are not limited to, halogen, azide, alkyl, aralkyl, alkenyl, alkynyl, cycloalkyl, hydroxyl, alkoxyl, amino, nitro, sulfhydryl, imino, amido, phosphonate, phosphinate, carbonyl, carboxyl, silyl, ether, alkylthio, sulfonyl, sulfonamido, ketone, aldehyde, thioketone, ester, heterocyclyl, —CN, aryl, aryloxy, perhaloalkoxy, aralkoxy, heteroaryl, heteroaryloxy, heteroarylalkyl, heteroaralkoxy, azido, alkylthio, oxo, acylalkyl, carboxy esters, carboxamido, acyloxy, aminoalkyl, alkylaminoaryl, alkylaryl, alkylaminoalkyl, alkoxyaryl, arylamino, aralkylamino, alkylsulfonyl, carboxamidoalkylaryl, carboxamidoaryl, hydroxyalkyl, haloalkyl, alkylaminoalkylcarboxy, aminocarboxamidoalkyl, cyano, alkoxyalkyl, perhaloalkyl, arylalkyloxyalkyl, and the like. In some embodiments, the substituent is selected from cyano, halogen, hydroxyl, and nitro.

As used herein, an “analog”, or “analogue” of a chemical compound is a compound that, by way of example, resembles another in structure but is not necessarily an isomer (e.g., 5-fluorouracil is an analog of thymine).

As used herein, a “derivative” of a compound refers to any compound having the same or a similar core structure to the compound but having at least one structural difference, including substituting, deleting, and/or adding one or more atoms or functional groups. The term “derivative” does not mean that the derivative is synthesized from the parent compound either as a starting material or intermediate, although this may be the case. The term “derivative” can include replacement of H by an alkyl, acyl, or amino group or a substituent described above. Derivatives can include compounds in which carboxyl groups in the parent compound have been derivatized to form salts, methyl and ethyl esters or other types of esters or hydrazides. Derivatives can include compounds in which hydroxyl groups in the parent compound have been derivatized to form O-acyl or O-alkyl derivatives. Derivatives can include compounds in which a hydrogen bond donating group in the parent compound is replaced with another hydrogen bond donating group such as OH, NH, or SH. Derivatives can include replacing a hydrogen bond acceptor group in the parent compound with another hydrogen bond acceptor group such as esters, ethers, ketones, carbonates, tertiary amines, imine, thiones, sulfones, tertiary amides, and sulfides.

Unless otherwise indicated, the term “polymer” includes both homopolymers and copolymers (e.g., polymers of two or more different monomers) and oligomers. Similarly, unless otherwise indicated, the use of a term designating a polymer class is intended to include homopolymers, copolymers and graft copolymers.

The term “molecular weight”, as used herein, generally refers to the mass or average mass of a material. If a polymer or oligomer, the molecular weight can refer to the relative average chain length or relative chain mass of the bulk polymer. In practice, the molecular weight of polymers and oligomers can be estimated or characterized in various ways including gel permeation chromatography (GPC) or capillary viscometry. GPC molecular weights are reported as the weight-average molecular weight (Mw) as opposed to the number-average molecular weight (Mn). Capillary viscometry provides estimates of molecular weight as the inherent viscosity determined from a dilute polymer solution using a particular set of concentration, temperature, and solvent conditions.

The term “small molecule”, as used herein, generally refers to an organic molecule that is less than 2000 g/mol in molecular weight, less than 1500 g/mol, less than 1000 g/mol, less than 800 g/mol, or less than 500 g/mol. Small molecules are non-polymeric and/or non-oligomeric.

The term “hydrophilic”, as used herein, refers to substances that have strongly polar groups that readily interact with water. Hydrophilic polymers can include acrylic acid homo- and co-polymers such as acrylamide, and maleic anhydride polymers and copolymers; amine-functional polymers such as allylamine, ethyleneimine, oxazoline, and other polymers containing amine groups in their main- or side-chains. The term hydrophilic, when used to refer to a polymer or oligomer, can mean a polymer or oligomer having a relative energy difference (RED=Rₐ/R₀, where Rₐ=Polymer/Solvent HSP Distance, R₀=Polymer Solubility Sphere Radius) of equal or less than 1 with respect to water in Hansen solubility space at 25° C.

The term “hydrophobic”, as used herein, refers to substances that lack an affinity for water; tending to repel and not absorb water as well as to not readily dissolve in or mix with water. The term hydrophobic, when used to refer to a polymer or oligomer, can mean a polymer or oligomer having a relative energy difference (RED=Rₐ/R₀, Rₐ=Polymer/Solvent HSP Distance, R₀=o Polymer Solubility Sphere Radius) greater than 1 with respect to water in Hansen solubility space at 25° C.

The term “amphiphilic”, as used herein, refers to a molecule combining hydrophilic and lipophilic (hydrophobic) properties. “Amphiphilic material” as used herein refers to a material containing a hydrophobic or more hydrophobic oligomer or polymer (e.g., biodegradable oligomer or polymer) and a hydrophilic or more hydrophilic oligomer or polymer. The term amphiphilic can refer to a polymer or oligomer having one or more hydrophobic oligomer segments and one or more hydrophilic oligomer segments as those terms are defined above.

The term “shear-stable,” as used herein, refers to a composition that is not substantially degraded when objected to a high fluid shear stress of at least 100 Pa. In some aspects, the shear stability is measured by applying shear stress using a rheometer, an internal flow cell, an external flow cell, or a spinning device in contact or in full submersion in a reference fluid having a well-defined shear rate viscosity profile. The applied shear rate can range from 0.1 s⁻¹ to thousands of s⁻¹ while the fluid shear stress obtained using these methods can range from low single digit Pa to thousands of Pa. Alternatively, a flat sample placed on a spin coater and spun up to tens of thousands of rpms in air can be used to determine the shear stability of a fluid applied to the sample.

Lubrication Methods

Methods are provided for applying or transferring a lubricant to a solid surface, and in particular to a hydrophobic textured surface. The methods allow for precise control over the amount of lubricant provided and alleviate problems associated with over-lubrication and/or waste of lubricants. The methods include using a carrier liquid suitable for the intended application and that, owing to the properties of the chosen carrier liquid, imparts some control over the amount of lubricant transferred to the surface.

The methods can include applying a lubricant composition described herein to the solid surface, e.g. to a hydrophobic textured surface. The lubricant in the composition is generally chosen such that it has a chemical affinity for the hydrophobic textured surface and spontaneously wets, spreads, and adheres to the solid surface to lubricate the surface. In some aspects, the surface is a hydrophobic textured surface. In some aspects, the hydrophobic textured surface has a roughness factor of about 1 or greater, and the lubricant spontaneously wets and spreads on the surface and adheres within the textured surface to form a stabilized liquid overlayer on the surface. In some aspects, the lubricant is stably adhered both within the texture of the surface and above the texture of the surface to form a stabilized liquid overlayer lubricating the surface.

In some aspects, the methods include applying a composition to the surface where the lubricant is a low surface tension liquid and the carrier is a high surface tension liquid. The low surface tension liquid can have a chemical affinity for the surface (e.g. an affinity for the hydrophobic textured surface, i.e. the low surface tension liquid has a positive spreading coefficient on the solid surface) and a surface tension (mN/m) that is lower than a surface energy (mJ/m²) value of the solid surface. The methods can include applying a sufficient amount of the lubricant and carrier such that the low surface tension liquid spontaneously wets and adheres to the hydrophobic textured surface when applied thereto to lubricate the hydrophobic textured surface. The high surface tension liquid preferentially dewets the hydrophobic textured surface (i.e. the high surface tension liquid has a negative spreading coefficient on the solid surface) and has a surface tension (mN/m) that is higher than the surface energy value (mJ/m²) of the hydrophobic textured surface. In some aspects, the low surface tension liquid and the high surface tension liquid are immiscible. In some aspects, the composition is an emulsion of the low surface tension liquid dispersed within the high surface tension liquid.

In some aspects, the methods include applying a composition to the surface where the lubricant is a high boiling liquid and the carrier is a low boiling liquid, e.g. where the carrier can be evaporated either at ambient conditions over time or by the application of a mild heating to leave the lubricant on the surface. In some aspects, the carrier (low boiling) liquid dewets from the surface spontaneously once applied.

The methods can be used to apply lubricant to any surface, and in particular to apply lubricant to a hydrophobic textured surface, in an amount effective to lubricate the surface. In some aspects, the methods are used to apply lubricant to a pre-lubricated textured surface to replace the lubricating liquid with a new lubricating liquid composition. The methods can allow for precise control over the amount of lubricant and/or the thickness of the lubricating liquid that is applied or transferred to the surface.

Methods of applying the compositions can include atomization, aspiration, air-assisted or airless spraying, electrospraying, or other means of applying the compositions to the surface. The methods can include applying a thin single coating of the compositions or, in some aspects, by applying multiple coatings or passes across the surface. The number of passes can be adjusted to ensure complete lubrication of the surface. The methods can include applying the lubricant in 1, 2, 3, 4, 5, or more passes. The number of passes can also be adjusted to control the amount or degree of lubrication, e.g. to only partially lubricate the surface or to apply the lubricant so that it does not form a liquid overlayer but is only retained within the structure of the textured surface. The methods can include applying the lubricant with little or no wasted lubricant. The methods can result in a transfer efficiency that is higher than the transfer efficiency applying the lubricant without the carrier, e.g. about 2, 3, 4, or 5 time higher transfer efficiency than the otherwise same methods using the same lubricant without the carrier. In some aspects, at least 90%, at least 95%, at least 98%, at least 99%, or more of the lubricant is effectively transferred to the surface. In some aspects, less than 10%, less than 5%, less than 2%, less than 1%, or less of the lubricant is wasted using the methods described herein.

Lubricant Compositions

The methods can include applying a lubricant composition including the lubricant and a suitable carrier. In some aspects, the carrier has a higher surface tension than the lubricant. In some aspects, the carrier has a lower boiling point than the lubricant. In some aspects, the lubricant and carrier are immiscible, and can be emulsified to form a stable emulsion of the lubricant in the carrier.

| Composition | Composition | Composition | Composition |
|---|---|---|---|
| type I | type II | type III | type IV |
| S_{L} > 0, S_{c} < 0 | S_{L} > 0, S_{c} > 0 | S_{L} > 0, S_{c} > 0 | S_{L} > 0, S_{c1} > 0, ..., |
| L and C are | b.p._{L} > b.p._{c} | b.p._{L} > b.p._{c} | S_{cn} > 0 |
| immiscible | L and C | L and C are | b.p._{L} > b.p._{c} |
| | are miscible | immiscible | L and C₁-Cₙ₋₁ are |
| | | | miscible |
| | | | L and Cₙ are |
| | | | immiscible |

In some aspects, a lubricant composition is provided having a first effective amount of a low surface tension liquid, wherein the low surface tension liquid has a chemical affinity for the surface and a surface tension (mN/m) that is lower than a surface energy (mJ/m2) of the surface, and wherein the first effective amount is such that the low surface tension liquid spontaneously wets and adheres to the surface when applied thereto to lubricate the surface; and a second effective amount of a high surface tension liquid, wherein the high surface tension liquid is immiscible with the low surface tension liquid and is non-reactive with the low surface tension liquid, wherein the high surface tension liquid preferentially dewets the surface and has a surface tension (mN/m) that is higher than the surface energy value (mJ/m2) of the surface, and wherein the second effective amount is effective to support an emulsion of the low surface tension liquid dispersed within the high surface tension liquid. In some aspects, the composition includes more than one high surface tension liquid, e.g. 2, 3, or more high surface tension liquids can be combined to form the carrier so long as each of the high surface tension liquids dewets the surface and have a surface tension (mN/m) that is higher than the surface energy value (mJ/m2) of the hydrophobic textured surface, and wherein the total amount of high surface tension liquids is effective to support an emulsion of the low surface tension liquid dispersed within the high surface tension liquids.

The compositions can form stable emulsions. For example, the emulsion of the low surface tension liquid dispersed within the high surface tension liquid can be stable for a period of time of at least 1 hours, at least 10 hours, at least 1 day, or at least 3 days at room temperature and 1 atmosphere. The low surface tension liquid and the high surface tension liquid can be mixed, e.g. via shear force-driven mixing such as overhead mixing, centrifugal mixing, rotor-stator mixing, static mixing, and mixing with an in-line microfluidizer; via atomization-driven mixing such as spraying, aspiration, siphoning, carburation, aeration, chemical injector using Bernoulli's principle, Venturi mechanism, spring/ball mechanism; or via ultrasonication.

In some aspects, a lubricant composition is provided having a first effective amount of a high boiling liquid, wherein the high boiling liquid has a chemical affinity for surface, and wherein the first effective amount is such that the high boiling liquid spontaneously wets and adheres to the surface when applied thereto to lubricate the surface; and a second effective amount of a low boiling liquid preferentially having chemical affinity and completely wetting to the surface, wherein the high boiling liquid is immiscible with and unreactive with the low boiling liquid, and wherein the second effective amount is effective to support an emulsion of the high boiling liquid dispersed within the low boiling liquid. In some aspects, the composition includes two or more low boiling liquids, e.g. 2, 3, or more low boiling liquids can be combined to form the carrier so long as the high boiling liquid is immiscible and unreactive with each of the low boiling liquids, preferentially where each of the low boiling liquids have a positive spreading coefficient to the solid surface and chemical affinity and completely wetting to the surface.

In some aspects, the relative boiling points of the high boiling liquid and the low boiling liquid are such that the low boiling liquid evaporates from the hydrophobic textured surface at standard temperature and pressure at a rate such that the low boiling liquid infuses the hydrophobic textured surface to lubricate the hydrophobic textured surface. In some aspects, the low boiling liquid has vapor pressure greater than that of the high boiling liquid under ambient pressure and temperature.

In some aspects, the composition is provided having a first effective amount of a high boiling liquid, wherein the high boiling liquid has a chemical affinity for the hydrophobic textured surface, and wherein the first effective amount is such that the high boiling liquid spontaneously wets and adheres to the hydrophobic textured surface when applied thereto to lubricate the hydrophobic textured surface; and a low boiling liquid preferentially having chemical affinity and completely wetting to the textured surface, wherein the high boiling liquid is miscible with and unreactive with the low boiling liquid.

In some aspects, the composition includes two or more low boiling liquids, e.g. 2, 3, or more low boiling liquids can be combined to form the carrier so long as the high boiling liquid is miscible and unreactive with the low boiling liquids, preferentially where each of the low boiling liquids have a positive spreading coefficient to the solid surface and chemical affinity and completely wetting to the surface.

In some aspects, the high boiling liquid further comprises a perfluoropolyether (PFPE), a silicone oil, a mineral oil, partially fluorinated hydrocarbon, a fluorosilane, perfluorosilane, perfluoroalkylether, chlorotrifluoroethylene, silicone oil, triglyceride, vegetable oil, molten wax, molten paraffin, or a mixture thereof. The high boiling liquid can have a viscosity from 1 cSt to 30,000 cSt under ambient condition. In some aspects, the high boiling liquid is selected from the group consisting of an oleophobic lubricant, an oleophilic lubricant, a hydrophobic lubricant, a hydrophilic lubricant, an amphiphilic lubricant, and a fluorophilic lubricant.

In some aspects, the low boiling liquid further includes water or an organic solvent selected from the group consisting of an alcohol, acetone, an ether, a hydrocarbon, a fluorinated solvent, an aromatic solvent, a ketone, an amine, a nitrated and halogenated hydrocarbon.

In some aspects, the compositions are mixed by one or more of the following techniques a) shear force-driven such as overhead mixing, centrifugal mixing, rotor-stator mixing, static mixing, and mixing with an in-line microfluidizer; b) atomization-driven such as spraying, aspiration, siphoning, carburation, aeration, chemical injector using Bernoulli's principle, Venturi mechanism, spring/ball mechanism; and c) ultrasonication.

In some aspects, the compositions can further include surfactants or stabilizers to stabilize the composition, e.g. to stabilize the emulsion. In some aspects, the lubricant composition is substantially free of particulate matter. In some aspects, the high surface tension liquid and/or the high boiling liquid are chosen such that they do not react and/or do not swell the hydrophobic textured surface when applied thereto.

### EXAMPLES

Now having described the embodiments of the present disclosure, in general, the following Examples describe some additional embodiments of the present disclosure. While embodiments of the present disclosure are described in connection with the following examples and the corresponding text and figures, there is no intent to limit embodiments of the present disclosure to this description. On the contrary, the intent is to cover all alternatives, modifications, and equivalents included within the spirit and scope of embodiments of the present disclosure.

Materials and Methods

Lubricants included a “KRYTOX” brand perfluoropolyether lubricant (GPL 101 available from The Chemours Company, Wilmington DE) and a trimethylsiloxy terminated polydimethylsiloxane lubricant (DMS-T11 available from Gelest Inc., Morrisville, Pa.). The substrates used were 1 mm thick and 3″×2″ glass slide (total substrate area=38.7 cm2) spray coated with a nanocomposite solution of fluorinated nanoparticles, fluorinated polymer binder, solvent, catalyst, and other additives as disclosed in U.S. provisional application 62/682,839, the contents of which are incorporated by reference. Carrier liquids included water, a “NOVEC” brand hydrofluoroether (HFE-7000 available from 3M, Maplewood Minn.), and ethanol.

For each sample, the total mass of infused liquid was determined by measuring the mass before and after lubrication. The pinning behavior of the surfaces were examined at each stage using 5 microliter ethanol droplets. The surfaces were imaged at each stage using Keyence optical microscope to determine surface smoothness and degree of lubricant infusion.

First Scenario: Fixed Concentration of Krytox (By Volume) and Change the Number of Passes

Lubricant Composition type 1: Krytox in water. 0.28 mL Krytox 101 (0.54 g) was added to 40 mL water in a plastic cup, followed by ultrasonication for 1 minute. The mass of the substrates were measured prior to any coating. Lubricant was applied by spraying onto the substrate in a number of passes from 1 to 4. The final mass was recorded after lubrication, and the surfaces were tested for pinning using ethanol droplet test. Lubricated surfaces were optically imaged using Keyence optical microscope. All samples were performed in triplicate.

TABLE 1
Textured surface mass before and after lubrication
as a function of number of passes.
Krytox K101 (‘active’) volume concentration
in water (‘carrier’) is fixed to 0.69%.
The difference in mass indicates the net transferred
lubricant mass to the textured surface.

| Textured surface | | Textured surface |
|---|---|---|
| mass before | | mass after |
| lubrication | Number of | lubrication |
| (mg) | passes | (mg) |
| 9.4936 | 1 | 9.4947 |
| 9.7941 | 1 | 9.7954 |
| 9.8203 | 1 | 9.8215 |
| 9.4127 | 2 | 9.4145 |
| 9.3484 | 2 | 9.3503 |
| 9.7638 | 2 | 9.7654 |
| 9.4282 | 3 | 9.4304 |
| 9.8622 | 3 | 9.8645 |
| 9.8043 | 3 | 9.8065 |
| 9.7810 | 4 | 9.7838 |
| 9.8120 | 4 | 9.8148 |
| 9.8193 | 4 | 9.8221 |

TABLE 9
Ethanol droplet test results and net transferred
lubricant mass on the textured
surface on a 3″ × 2″ glass slide
(total substrate area = 38.7 cm²) as a function of
increasing the number of application passes.
Krytox K101 (‘active’) vol % in water
(‘carrier’) is fixed to 0.69%.

| | | Net lubricant | |
|---|---|---|---|
| | Number | mass | |
| Sample | of | transferred | Pinning/ |
| No. | passes | (mg) | No pinning |
| 1 | 1 | 1.1 | Pinning |
| 2 | 1 | 1.3 | Pinning |
| 3 | 1 | 1.2 | Pinning |
| 4 | 2 | 1.8 | Pinning |
| 5 | 2 | 1.9 | Pinning |
| 6 | 2 | 1.6 | Pinning |
| 7 | 3 | 2.2 | Pinning |
| 8 | 3 | 2.3 | Pinning |
| 9 | 3 | 2.2 | Pinning |
| 10 | 4 | 2.8 | No pinning |
| 11 | 4 | 2.8 | No pinning |
| 12 | 4 | 2.8 | No pinning |

The results in Table 9 show that there is a minimum transferred lubricant mass needed to get fully slippery surface without pinning. For 0.69 vol % K101 in water, 4 passes are needed to achieve sufficient lubricant mass (2.8 mg) to eliminate random pinning on the surface.

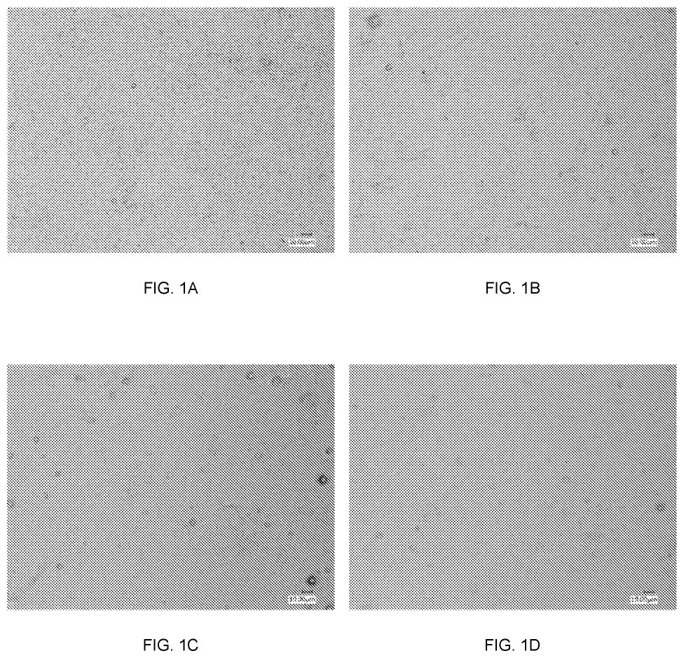

Surface smoothness as a function of transferred lubricant mass was evaluated using Keyence optical microscope and the results are shown in FIG. 1. The results in FIG. 1 show that with increasing lubricant mass transferred to the textured surface, the surface becomes smoother as more lubricant covers the texture. At low transferred lubricant mass (approx. below 2 mg), lubricant thickness is not enough to fully cover surface texture which may lead to pinning points as shown in our ethanol droplet test results. These results support ethanol droplet test results where increasing transferred lubricant mass allows fully slippery surface (i.e. SLIPS) and eliminates pinning points on the surface.

Lubricant Composition type 2: Krytox in HFE-7000. 2 mL Krytox 101 (3.78 g) was added to 40 mL HFE-7000 in a plastic cup, followed by ultrasonication for 1 minute. The mass of the substrates were measured prior to any coating. Lubricant was applied by spraying onto the substrate in a number of passes from 1 to 5. The final mass was recorded after lubrication, and the surfaces were tested for pinning using ethanol droplet test. Lubricated surfaces were optically imaged using Keyence optical microscope. All samples were performed in triplicate.

TABLE 2
Textured surface mass before and after lubrication as a
function of number of passes.
Krytox K101 (‘active’) volume concentration in
HFE-7000 (‘carrier’) is fixed to 4.76%. The difference in
mass indicates the net transferred lubricant mass
on the textured surface.

| Textured | | Textured |
|---|---|---|
| surface mass | | surface mass |
| before | Number | after |
| lubrication | of | lubrication |
| (mg) | passes | (mg) |
| 9.5573 | 1 | 9.5584 |
| 9.5380 | 1 | 9.5390 |
| 9.5448 | 1 | 9.5457 |
| 9.5397 | 2 | 9.5416 |
| 9.5515 | 2 | 9.5530 |
| 9.6642 | 2 | 9.6653 |
| 9.5504 | 3 | 9.5526 |
| 9.4852 | 3 | 9.4871 |
| 9.5561 | 3 | 9.5578 |
| 9.5495 | 4 | 9.5518 |
| 9.5507 | 4 | 9.5529 |
| 9.6641 | 4 | 9.6661 |
| 9.6435 | 5 | 9.6466 |
| 9.6766 | 5 | 9.6800 |
| 9.6194 | 5 | 9.6225 |

TABLE 10
Ethanol droplet test results and net transferred lubricant mass on a textured
surface lubricated with varying Krytox lubricant (‘active’) concentration in
HFE-7000 (‘carrier’). Krytox K101 volume concentration in HFE-7000
is fixed to 4.76%

| Sample | Number | Net transferred | Pinning/ |
|---|---|---|---|
| No. | of passes | lubricant mass (mg) | No pinning |
| 1 | 1 | 1.1 | pinning |
| 2 | 1 | 1.0 | pinning |
| 3 | 1 | 0.9 | pinning |
| 4 | 2 | 1.9 | No pinning |
| 5 | 2 | 1.5 | pinning |
| 6 | 2 | 1.5 | pinning |
| 7 | 3 | 2.2 | No pinning |
| 8 | 3 | 1.9 | No pinning |
| 9 | 3 | 1.7 | Pinning |
| 10 | 4 | 2.3 | No pinning |
| 11 | 4 | 2.2 | No pinning |
| 12 | 4 | 2.0 | No pinning |
| 13 | 5 | 3.1 | No pinning |
| 14 | 5 | 3.4 | No pinning |
| 15 | 5 | 3.1 | No pinning |

The results in Table 10 show that there is a minimum transferred lubricant mass needed to get fully slippery surface without pinning. For 4.76 vol % K101 in HFE-7000, around 4 passes are needed to achieve sufficient transferred lubricant mass (2.8 mg) to eliminate random pinning on the surface.

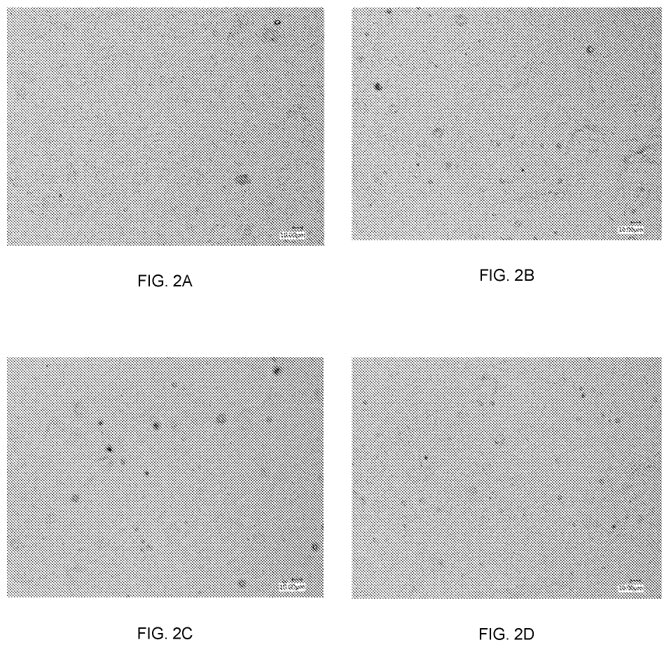

Surface smoothness as a function of lubricant mass was evaluated using Keyence optical microscope and the results are shown in FIG. 2. The results in FIG. 2 show a similar trend to lubrication with Krytox in water. With increasing transferred lubricant mass, the surface becomes smoother as more lubricant covers the texture. At low transferred lubricant mass (approx. below 1.5 mg), lubricant thickness is not enough to fully cover the surface texture which may lead to random pinning points as shown in our ethanol droplet test results. These results support our ethanol droplet test results where increasing transferred lubricant mass allows fully slippery surface (i.e. SLIPS) and eliminates pinning points on the surface.

Lubricant Composition type 3: Krytox in Ethanol. 0.5 mL Krytox 101 (0.54 g) was added to 40 mL Ethanol in a plastic cup, followed by ultrasonication for 1 minute. The mass of the substrates were measured prior to any coating. Lubricant was applied by spraying onto the substrate in a number of passes from 1 to 5. The final mass was recorded after lubrication, and the surfaces were tested for pinning using ethanol droplet test. Lubricated surfaces were optically imaged using Keyence optical microscope. All samples were performed in triplicate.

TABLE 3
Textured surface mass before and after lubrication as a function of
number of passes. Krytox K101 (‘active’) volume concentration in
ethanol (‘carrier’) is fixed to 1.23%. The difference in mass
indicates the net transferred lubricant mass on the textured surface.

| Textured surface mass | Number | Textured surface mass after |
|---|---|---|
| before lubrication (mg) | of passes | lubrication (mg) |
| 9.2169 | 1 | 9.2181 |
| 9.1433 | 1 | 9.1443 |
| 9.1516 | 1 | 9.1525 |
| 9.1440 | 2 | 9.1453 |
| 9.1995 | 2 | 9.2007 |
| 9.1609 | 2 | 9.1618 |
| 9.1727 | 3 | 9.1750 |
| 9.1315 | 3 | 9.1337 |
| 9.1985 | 3 | 9.1996 |
| 9.2122 | 4 | 9.2156 |
| 9.1497 | 4 | 9.1530 |
| 9.1905 | 4 | 9.1930 |
| 9.1816 | 5 | 9.1857 |
| 9.1492 | 5 | 9.1535 |
| 9.1843 | 5 | 9.1882 |

TABLE 11
Ethanol droplet test results and net transferred lubricant mass on a
textured surface lubricated with varying number of application passes.
Krytox K101 (‘active’) volume concentration in ethanol (‘carrier’)
is fixed to 1.23%

| Sample | Number | Net transferred | Pinning/ |
|---|---|---|---|
| No. | of passes | lubricant mass (mg) | No Pinning |
| 1 | 1 | 1.2 | Pinning |
| 2 | 1 | 1.0 | Pinning |
| 3 | 1 | 0.9 | Pinning |
| 4 | 2 | 1.3 | Pinning |
| 5 | 2 | 1.2 | Pinning |
| 6 | 2 | 0.9 | Pinning |
| 7 | 3 | 2.3 | No pinning |
| 8 | 3 | 2.3 | No pinning |
| 9 | 3 | 1.1 | Pinning |
| 10 | 4 | 3.4 | No pinning |
| 11 | 4 | 3.3 | No pinning |
| 12 | 4 | 2.6 | No pinning |
| 13 | 5 | 4.1 | No pinning |
| 14 | 5 | 4.3 | No pinning |
| 15 | 5 | 3.9 | No pinning |

The results in Table 11 show that there is a minimum transferred lubricant mass needed to get fully slippery surface without pinning. For 1.23 vol % K101 in ethanol, around 4 passes are needed to achieve sufficient transferred lubricant mass (2.8 mg) to eliminate random pinning on the surface.

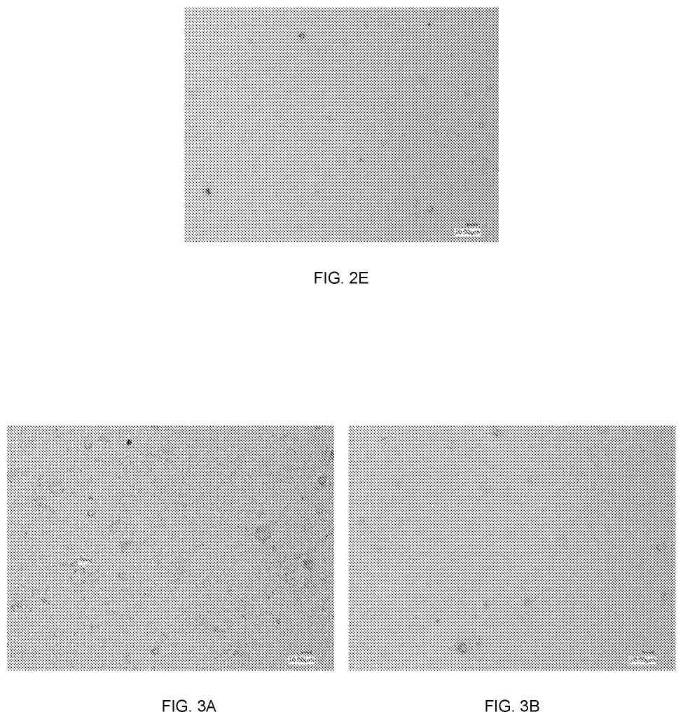

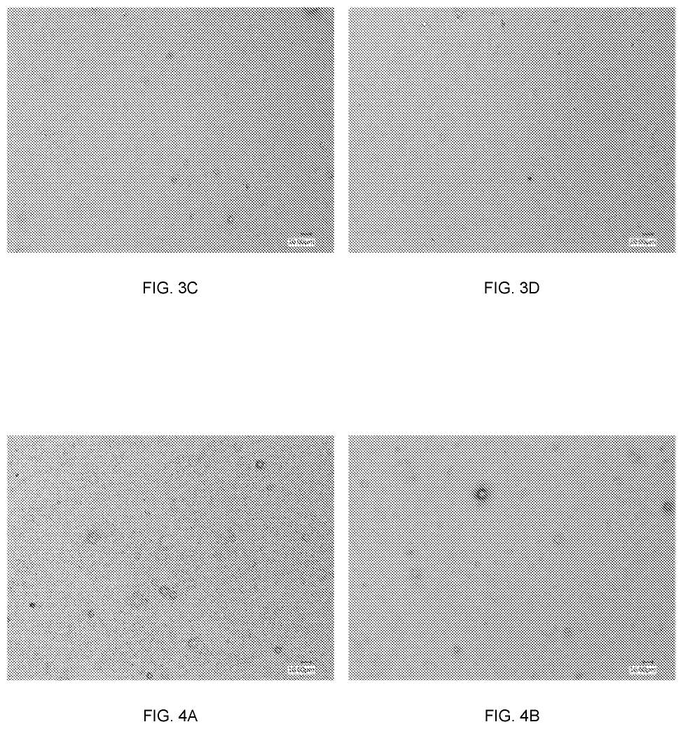

Surface smoothness as a function of lubricant mass was evaluated using Keyence optical microscope and the results are shown in FIG. 3. The results in FIG. 3 show similar trend to lubrication with Krytox in HFE-7000 or water. With increasing transferred lubricant mass, the surface becomes smoother as more lubricant covers the texture. At low transferred lubricant mass (approx. below 2 mg), lubricant thickness is not enough to fully cover surface texture which may lead to random pinning points as shown in our ethanol droplet test results. These results support our ethanol droplet test results where increasing transferred lubricant mass allows fully slippery surface (i.e. SLIPS) and eliminates pinning points on the surface.

Second Senario: Fixed Nmber of Passes and Vary Krytox Concentration (By Volume)

Lubricant Composition type 1: Krytox in water. Varying amounts of Krytox 101 were added to 40 mL water in a plastic cup, followed by ultrasonication for 1 minute. The amounts of Krrytox added were 0.07 mL, 0.14 mL, 0.28 mL, and 0.84 mL, corresponding to 0.132 g, 0.267 g, 0.529 g, and 1.580 g respectively. The mass of the substrates were measured prior to any coating. Lubricant was applied by spraying onto the substrate in 4 passes. The final mass was recorded after lubrication, and the surfaces were tested for pinning using ethanol droplet test. Lubricated surfaces were optically imaged using Keyence optical microscope. All samples were performed in triplicate.

TABLE 4
Textured surface mass before and after lubrication as a function of Krytox
vol % in water (number of passes is fixed to 4 passes). The difference in
mass indicates the net transferred lubricant mass on the textured surface.

| Textured surface mass | Krytox vol % | Textured surface mass |
|---|---|---|
| before lubrication (mg) | in water | after lubrication (mg) |
| 9.1979 | 0.175 | 9.1984 |
| 9.1969 | 0.175 | 9.1973 |
| 9.1737 | 0.175 | 9.1740 |
| 9.2309 | 0.348 | 9.2334 |
| 9.1994 | 0.348 | 9.2015 |
| 9.1938 | 0.348 | 9.1958 |
| 9.1898 | 0.695 | 9.1943 |
| 9.2024 | 0.695 | 9.2069 |
| 9.1732 | 0.695 | 9.1769 |
| 9.2099 | 2.030 | 9.2232 |
| 9.1906 | 2.030 | 9.2048 |
| 9.1884 | 2.030 | 9.2015 |

TABLE 12
Ethanol droplet test results and net transferred lubricant mass on a
textured surface lubricated with varying Krytox lubricant (‘active’)
concentration in water (‘carrier’). Number of passes is fixed to 4.

| Sample | Krytox vol % in | Net transferred | Pinning/ |
|---|---|---|---|
| No. | water | lubricant mass (mg) | No Pinning |
| 1 | 0.175 | 0.5 | Pinning |
| 2 | 0.175 | 0.4 | Pinning |
| 3 | 0.175 | 0.3 | Pinning |
| 4 | 0.348 | 2.5 | Pinning |
| 5 | 0.348 | 2.1 | Pinning |
| 6 | 0.348 | 2.0 | Pinning |
| 7 | 0.695 | 4.5 | No pinning |
| 8 | 0.695 | 4.5 | No pinning |
| 9 | 0.695 | 3.8 | No pinning |
| 10 | 2.030 | 13.3 | No pinning |
| 11 | 2.030 | 14.2 | No pinning |
| 12 | 2.030 | 13.1 | No pinning |

The results in Table 12 show that there is a minimum transferred lubricant mass needed to get fully slippery surface without pinning as also shown previously. It can be seen that at low Krytox concentration (0.17 vol %), 4 passes are not enough to achieve fully slippery surface (i.e. SLIPS), while at high Krytox concentration (2.03 vol %), 4 passes result in over-lubrication. In order to achieve fully slippery surface without pinning and without excessive over-lubrication, 4 passes of 0.69 vol % K101 in water are needed.

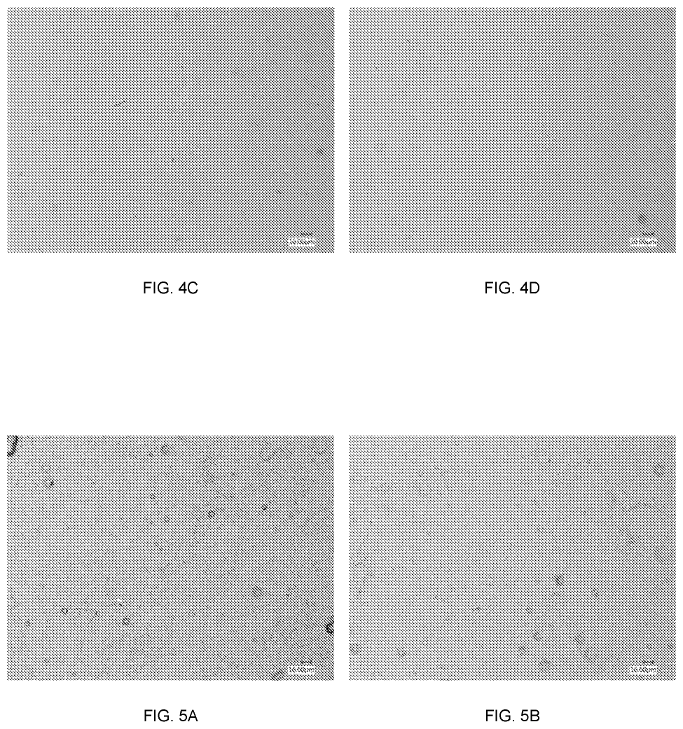

Surface smoothness as a function of Krytox lubricant (‘active’) concentrations in water (‘carrier’) with a constant 4 passes was evaluated using Keyence optical microscope and the results are shown in FIG. 4.

The results in FIG. 4 show that with increasing the Krytox lubricant concentration in water (while fixing number of passes), the surface becomes smoother as more lubricant covers the texture. At low lubricant concentrations, 4 passes are not sufficient and lubricant thickness is not enough to fully cover surface texture which lead to random pinning points as shown in our ethanol droplet test results. These results support ethanol droplet test results where increasing transferred lubricant mass covers more of the textured surface, allows fully slippery surface, and eliminates pinning points on the surface.

Lubricant Composition 2: Krytox in HFE-7000. Varying amounts of Krytox 101 were added to 40 mL HFE-7000 in a plastic cup, followed by ultrasonication for 1 minute. The amounts of Krrytox added were 0.25 mL, 1 mL, 2 mL, and 4 mL, corresponding to 0.945 g, 1.89 g, 3.78 g, and 5.67 g respectively. The mass of the substrates were measured prior to any coating. Lubricant was applied by spraying onto the substrate in 4 passes. The final mass was recorded after lubrication, and the surfaces were tested for pinning using ethanol droplet test. Lubricated surfaces were optically imaged using Keyence optical microscope. All samples were performed in triplicate.

TABLE 5
Textured surface mass before and after lubrication as a function of
Krytox vol % in HFE-7000 (number of passes is fixed to 4 passes).
The difference in mass indicates the net transferred lubricant mass
on the textured surface.

| Textured surface | | Textured surface |
|---|---|---|
| mass before | Krytox vol % | mass after |
| lubrication (mg) | in HFE-7000 | lubrication (mg) |
| 9.1446 | 0.62 | 9.1457 |
| 9.2025 | 0.62 | 9.2035 |
| 9.2039 | 0.62 | 9.2046 |
| 9.2112 | 2.43 | 9.2134 |
| 9.1829 | 2.43 | 9.1853 |
| 9.1682 | 2.43 | 9.1708 |
| 9.1742 | 4.76 | 9.1776 |
| 9.2001 | 4.76 | 9.2033 |
| 9.1560 | 4.76 | 9.1591 |
| 9.1565 | 9.09 | 9.1775 |
| 9.2520 | 9.09 | 9.2718 |
| 9.1425 | 9.09 | 9.1582 |

TABLE 13
Ethanol droplet test results and net transferred lubricant mass on a
textured surface lubricated with varying Krytox lubricant (‘active’)
concentration in HFE-7000 (‘carrier’). Number of passes is fixed to 4.

| Sample | Krytox K101 vol % | Net transferred | Pinning/ |
|---|---|---|---|
| No. | in HFE-7000 | lubricant mass (mg) | No pinning |
| 1 | 0.62 | 1.1 | Pinning |
| 2 | 0.62 | 1.1 | Pinning |
| 3 | 0.62 | 1.1 | Pinning |
| 4 | 2.43 | 2.2 | Pinning |
| 5 | 2.43 | 2.4 | Pinning |
| 6 | 2.43 | 2.6 | Pinning |
| 7 | 4.76 | 3.4 | No pinning |
| 8 | 4.76 | 3.2 | No pinning |
| 9 | 4.76 | 3.1 | No pinning |
| 10 | 9.09 | 21.0 | No pinning |
| 11 | 9.09 | 19.8 | No pinning |
| 12 | 9.09 | 15.7 | No pinning |

The results in Table 13 show that there is a minimum transferred lubricant mass needed to get fully slippery surface without pinning as also shown previously. At low Krytox concentration (0.62 vol %), 4 passes are not enough to achieve fully slippery surface (i.e. SLIPS), while at high Krytox concentration (9.09 vol %), 4 passes result in over-lubrication. In order to achieve fully slippery surface without pinning and without excessive over-lubrication, 4 passes of 4.76 vol % K101 in HFE-7000 are needed.

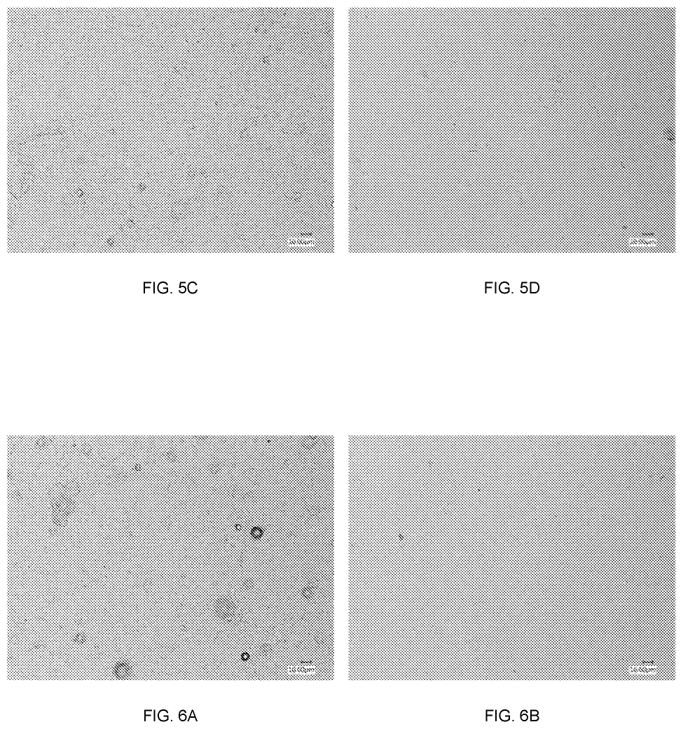

Surface smoothness as a function of Krytox lubricant (‘active’) concentrations in HFE-7000 (‘carrier’) with a constant 4 passes was evaluated using Keyence optical microscope and the results are shown in FIG. 5.

The results in FIG. 5 show that with increasing Krytox lubricant concentration in HFE-7000 (while fixing number of passes), the surface becomes smoother as more lubricant covers the texture. At low lubricant concentrations, 4 passes are not sufficient and lubricant thickness is not enough to fully cover surface texture which lead to random pinning points as shown in our ethanol droplet test results. These results support ethanol droplet test results where increasing transferred lubricant mass covers more of the textured surface, allows fully slippery surface, and eliminates pinning points on the surface.

Lubricant Composition 3: Krytox in Ethanol. Varying amounts of Krytox 101 were added to 40 mL ethanol in a plastic cup, followed by ultrasonication for 1 minute. The amounts of Krrytox added were 0.125 mL, 0.5 mL, 1 mL, and 2 mL. The mass of the substrates were measured prior to any coating. Lubricant was applied by spraying onto the substrate in 4 passes. The final mass was recorded after lubrication, and the surfaces were tested for pinning using ethanol droplet test. Lubricated surfaces were optically imaged using Keyence optical microscope. All samples were performed in triplicate.

TABLE 6
Textured surface mass before and after lubrication as a function of
K101 vol % in ethanol (number of passes is fixed to 4 passes).
The difference in mass indicates the net transferred lubricant mass
on the textured surface.

| Textured surface | | Textured surface |
|---|---|---|
| mass before | Krytox vol % | mass after |
| lubrication (mg) | in ethanol | lubrication (mg) |
| 9.2240 | 0.311 | 9.2254 |
| 9.2484 | 0.311 | 9.2497 |
| 9.2735 | 0.311 | 9.2747 |
| 9.2129 | 1.234 | 9.2165 |
| 9.1735 | 1.234 | 9.1772 |
| 9.2106 | 1.234 | 9.2136 |
| 9.2025 | 2.439 | 9.2114 |
| 9.1961 | 2.439 | 9.2046 |
| 9.2839 | 2.439 | 9.2929 |
| 9.2227 | 4.762 | 9.2527 |
| 9.2790 | 4.762 | 9.3092 |
| 9.2490 | 4.762 | 9.2783 |

TABLE 14
Ethanol droplet test results and net transferred lubricant mass on a textured
surface lubricated with varying Krytox lubricant (‘active’) concentration in
ethanol (‘carrier’). Number of passes is fixed to 4.

| Sample | Krytox vol % | Net transferred | Pinning/ |
|---|---|---|---|
| No. | in Ethanol | lubricant mass (mg) | No pinning |
| 1 | 0.31 | 1.4 | Pinning |
| 2 | 0.31 | 1.3 | Pinning |
| 3 | 0.31 | 1.3 | Pinning |
| 4 | 1.23 | 3.9 | No Pinning |
| 5 | 1.23 | 3.7 | No Pinning |
| 6 | 1.23 | 3.0 | No Pinning |
| 7 | 2.43 | 8.9 | No pinning |
| 8 | 2.43 | 8.5 | No pinning |
| 9 | 2.43 | 9.0 | No pinning |
| 10 | 4.76 | 30.0 | No pinning |
| 11 | 4.76 | 30.2 | No pinning |
| 12 | 4.76 | 27.8 | No pinning |

The results in Table 14 show that there is a minimum transferred lubricant mass needed to get fully slippery surface without pinning as also shown previously. At low Krytox concentration (0.31 vol %), 4 passes are not enough to achieve fully slippery surface (i.e. SLIPS), while at high Krytox concentration (4.76 vol %), 4 passes result in over-lubrication. In order to achieve fully slippery surface without pinning and without excessive over-lubrication, 4 passes of 1.23 vol % K101 in ethanol are needed.

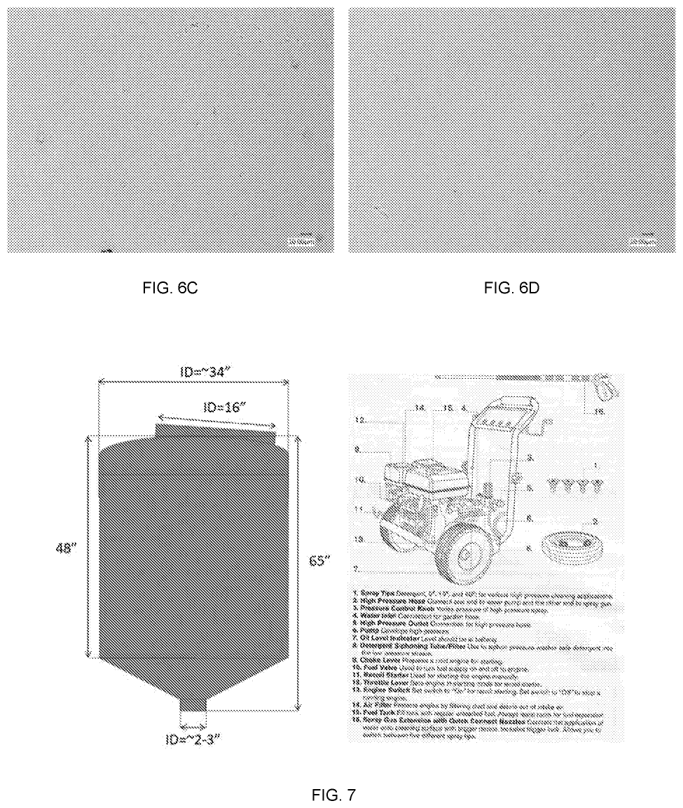

Surface smoothness as a function of Krytox lubricant ('active) concentrations in ethanol (‘carrier’) with a constant 4 passes was evaluated using Keyence optical microscope and the results are shown in FIG. 6.

The results in FIG. 6 show that with increasing lubricant concentration in ethanol (while fixing number of passes), the surface becomes smoother as more lubricant covers the texture. At low lubricant concentrations, 4 passes are not sufficient and lubricant thickness is not enough to fully cover surface texture which lead to random pinning points as shown in our ethanol droplet test results. These results support ethanol droplet test results where increasing transferred lubricant mass covers more of the textured surface, allows fully slippery surface, and eliminates pinning points on the surface.

Replenishing Underlubricated Surface

Substrates lubricated with Krytox 101 were examined for pinning behavior using the ethanol drop test, where surfaces exhibiting pinning behavior were selected as lacking sufficient lubrication. The mass of the underlubricated substrates was taken both prior to and immediately following lubricant application. 0.28 mL Krytox 101 (0.54 g) was added to 40 mL water in a plastic cup, followed by ultrasonication for 1 minute. The additional lubricant was applied via spraying in multiple passes to achieve approximately 3.5 mg lubricant mass. The final mass was recorded, the surface was imaged optically, and the pinning behavior was again examined with ethanol droplet test.

TABLE 7
shows that underlubricated surface can be replenished and turn back to
a fully slippery surface (i.e. SLIPS) with applying more lubricant until
the desired total transferred lubricant mass is reached, and as a result,
ethanol droplet slides on the surface. The difference in mass indicates
the net additional transferred lubricant mass on the textured surface.

| | Number of Passes to | |
|---|---|---|
| Mass of | achieve approx. 3.5 mg | Mass of textured |
| underlubricated | total transferred lubricant | surface after |
| textured surface | mass (0.69 vol % | additional |
| (mg) | K101 in water) | lubrication (mg) |
| 9.4947 | 3 | 9.4969 |

TABLE 15
shows that underlubricated surface can be replenished and turn back to
a fully slippery surface (i.e. SLIPS) with applying more lubricant until
the desired total transferred lubricant mass is reached, and as a result,
ethanol droplet slides on the surface. The difference in mass indicates
the net additional transferred lubricant mass on the textured surface.

| | Number of Passes | | |
|---|---|---|---|
| | to achieve approx. | | |
| | 3.5 mg total | | |
| mass of | transferred | Mass of | |
| underlubricated | lubricant mass | textured surface | |
| textured surface | (0.69 vol % K101 | after additional | Pinning/ |
| (mg) | in water) | lubrication (mg) | No pinning |
| 1.1 | 3 | 3.3 | No pinning |

Application of Silicone Lubricants With Water

1.04 mL silicone oil (0.529 g) was added to 40 mL water in a plastic cup, followed by ultrasonication for 1 minute. The mass of the substrates were measured prior to any coating. Lubricant was applied by spraying onto the substrate in a number of passes to achieve approximately 3.5 mg lubricant mass. The final mass was recorded after lubrication, and the surfaces were tested for pinning using ethanol droplet test. Lubricated surfaces were optically imaged using Keyence optical microscope. All samples were performed in triplicate.

TABLE 8
Textured surface mass before and after lubrication (silicone oil
concentration in water is fixed to 2.53 vol %). The difference in mass
indicates the net transferred lubricant mass on the textured surface.

| Textured surface | Number of Passes to | Textured surface |
|---|---|---|
| mass before | achieve approx. 3.5 mg | mass after |
| lubrication (mg) | transferred lubricant mass | lubrication (mg) |
| 9.1263 | 8 | 9.1300 |

TABLE 16
silicone oil emulsion in water

| | | Net transferred | |
|---|---|---|---|
| Sample | silicone oil | lubricant mass | Dewetting/Wetting |
| No. | vol % in water | (mg) | the surface? |
| 1 | 2.3 | 3.7 | Partially wetting |
| | | | the surface |

Table 16 shows that a similar method can be used to apply silicone oil (‘active’) lubricant in water (‘carrier’) on the textured surface. The reason for the ethanol droplet partially wetting is due to the low surface tension of ethanol and displacing silicone oil on a textured surface.

### Using Multicarrier Approach for Lubricating 200-Gallon Chemical Processing Tank

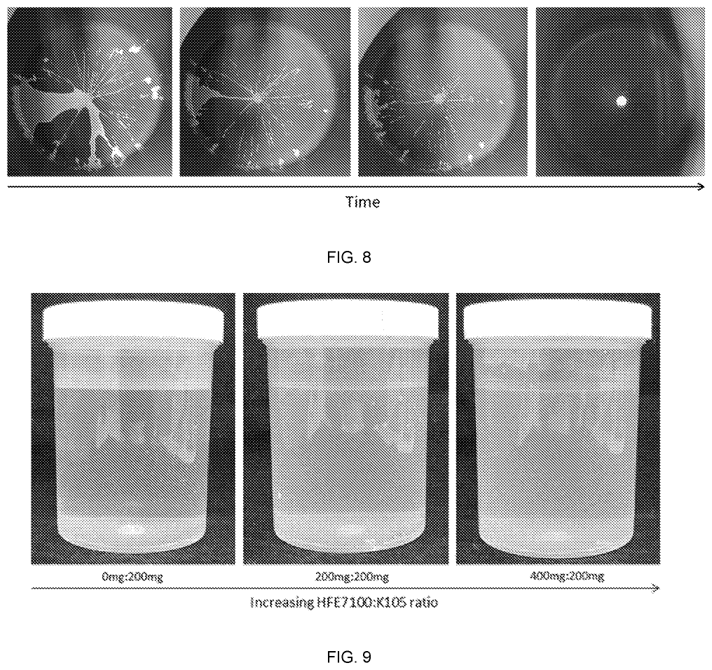

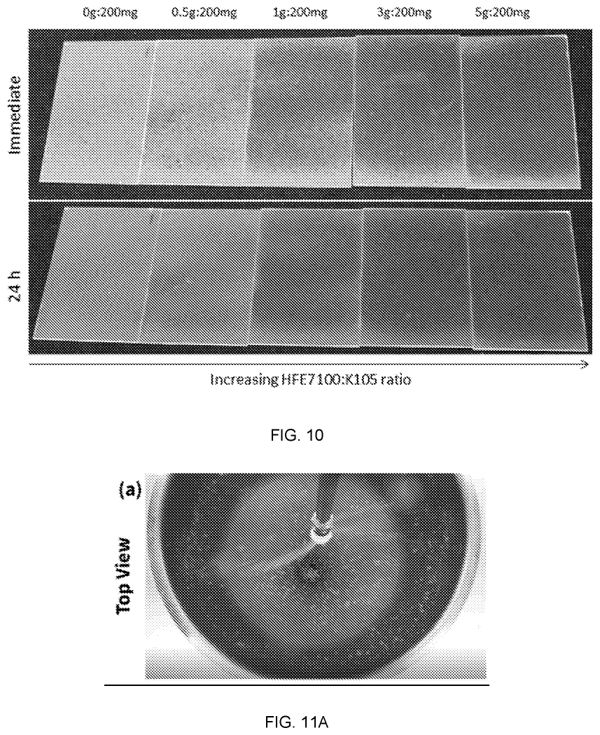

124.12 g of Krytox 103 is dissolved in 41.32 g of Novec hydrofluoroether (HFE-7100). The solution was then injected into the water stream of the BE Commercial Pressure Washers system (Comet BWD 2020 E-K) through chemical injector valve and sprayed inside the 200 Gallon tank at 1500 PSI (FIG. 7). The tank was then filled with a viscous polymer solution and the drainage was observed as shown in FIG. 8. The complete drainage of the tank is ideal performance and indicates that a sufficient amount of liquid solution was applied to achieve this.

### Using More Than One Carrier Liquid for Improved Transfer Efficiencies

200 mg of Krytox 105 is added in 3 g of Novec hydrofluoroether (HFE -7100) solvent and then mixed and sonicated with 180 g of DI water for 6 min to obtain a multicarrier emulsion. Emulsion, when sprayed using air gun provides better transfer into the coating and improved leveling of lubricant than spraying standalone Krytox 105 emulsion in water. This effect is more pronounced when spraying higher viscosity Krytox grades.

Application of Lubricant Using a Clean-In-Place (CIP) System

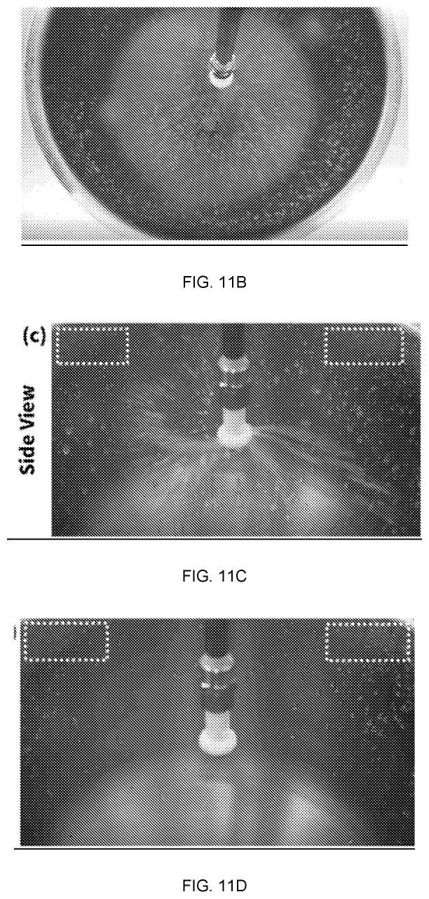

5 g of Krytox 107 is dosed by a venturi valve with a ⅓ turn (see FIGS. 11A-11D). The inlet pressure of the water is fixed to 150 psi and is regulated by a pneumatic pump. The system is actuated until water continuously de-wets the surface and droplets slide easily off the surface. The change in the gloss from matte to glossy due to the application of the lubricant is observed and is used to indicate coverage.

Application of Lubricant Using a Pressure Washer Fitted With a Venturi Valve at High Pressures

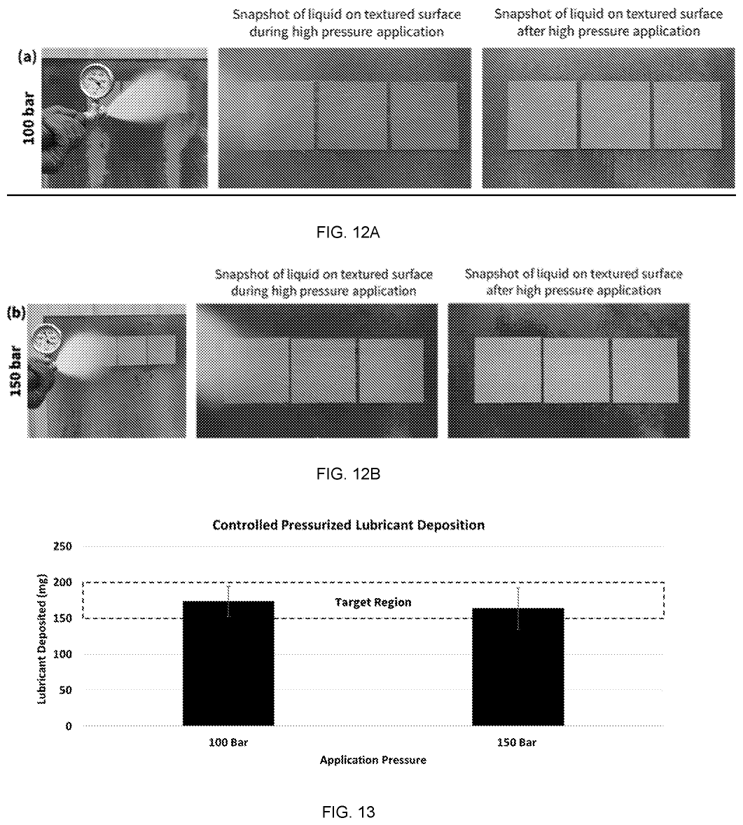

Krytox 107 is injected at a controlled rate using a venturi valve fitted to an industrial water pressure washer and is applied to stainless steel panels coated with a textured hydrophobic coating. Once the panels show de-wetting of water from the surface the application is stopped as the minimal functional amount required is applied as shown in FIGS. 12A-12B. The panels were weighed before and after application and the targeted amount of lubricant required is achieved as shown in FIG. 13.

### Examining the Effect of Injection Rate, Water Pressure and Distance on Transfer Efficiency Using a Pressure Washer

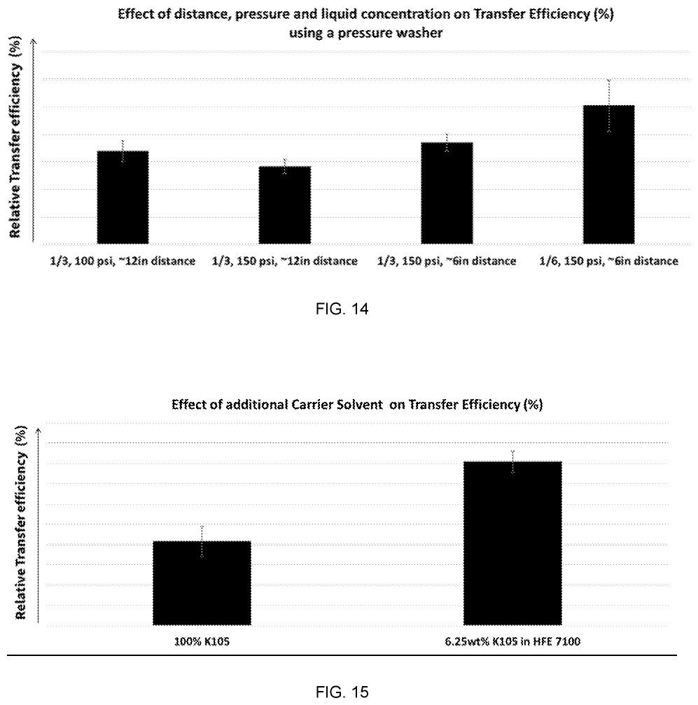

The effect of injection rate, water pressure and distance from surface is examined using a pressure washing wand fitted to a pneumatic water pump. One-gallon hoppers coated with the hydrophobic textured coating are used as test substrates. The test conditions are listed in Table 17. The transfer efficiency for each condition is determined. As seen in FIG. 14 the transfer efficiency improves as the distance to the surface decreases due to the increased pressure at the wall and the transfer efficiency increases as the effective concentration of the lubricant is decreased.

TABLE 17
Test conditions for low pressure application using a venturi valve
injection method

| Venturi Valve | Water Pressure | Distance from |
|---|---|---|
| Opening (Turn) | (psi) | Surface (in) |
| 1/3 | 100 | 12 |
| 1/3 | 150 | 12 |
| 1/3 | 150 | 6 |
| 1/6 | 150 | 6 |

### Effect of Additional Carrier Liquid on Transfer Efficiency

The effect of additional carrier liquids examined using a pressure washing wand fitted to a pneumatic water pump. The liquid solution is introduced to the system via a venturi valve with a ⅙ turn, the water pressure is fixed to 80 psi and the distance from the surface is fixed to 6 in. One-gallon hoppers coated with the hydrophobic textured coating are used as test substrates. The hoppers are weighed before and after the liquid application and the transfer efficiency is calculated as follows:

$$( \frac{{m}_{final substrate} - {m}_{initial substrate}}{{m}_{initial liquid}} ) \times 100$$

The pressure washing system is actuated until visually the surface transitioned from matte to glossy. As shown in FIG. 15 the transfer efficiency improves when an additional carrier solvent is used as the effective concentration of the liquid decreases and can be controlled more precisely.

How to Determine Target Lubricant Amount for Application

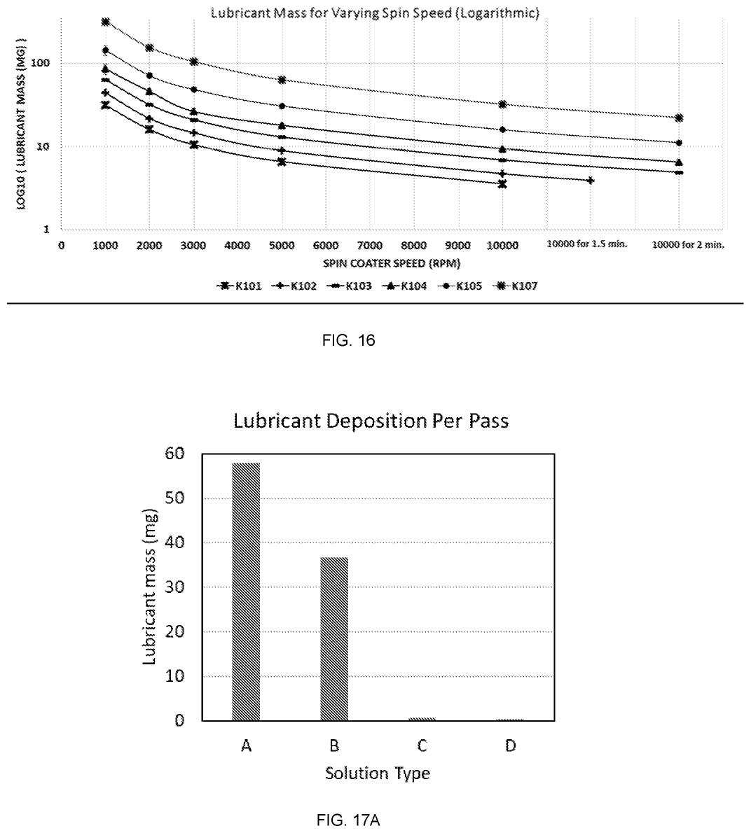

The target mass of lubricant is determined by spin coating a 2″×3″ glass slide at high shear in a spin coater. This number is converted into a density (mg-cm⁻²) and this number is used to extrapolate the amount of lubricant required for larger surface areas. FIG. 16 shows the target mass is pure liquid is used for the application.

### Optimization of Emulsion Mixture for Uniform and Controlled Spray Application to Avoid Over Lubrication

Solutions are prepared as given in Table below. Mixtures are then ultra-sonicated for 30 seconds and sprayed on glass slides coated with a hydrophobic coating until transparency is achieved indicating full lubrication. Weight measurements were taken before and after lubrication and number of spray passes were recorded to fully lubricate the slides by respective solutions.

TABLE 18
Compositions of solutions tested

| | | No. of | Method of |
|---|---|---|---|
| Solution | Krytox 105:Water:Novec7100 | passes | Application |
| A | 1:0:0 | 1 | Spray |
| B | 0.5:0.5:0 | 4 | Spray |
| C | 0.05:0.95:0 | 10 | Spray |
| D | 0.003125:0.95:0.0468 | 7 | Spray |
| E | 0.05:0:0.95 | N/A | Spin Coating |

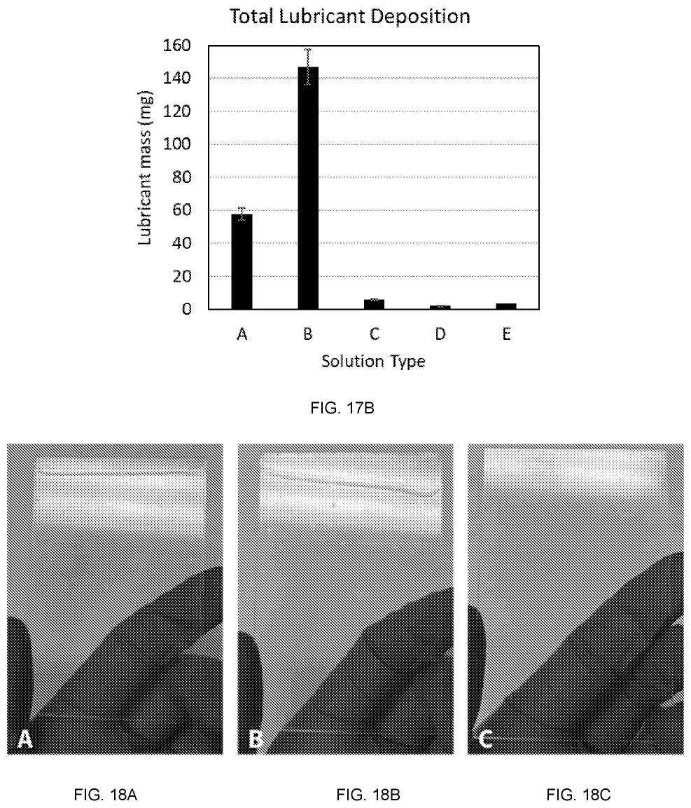

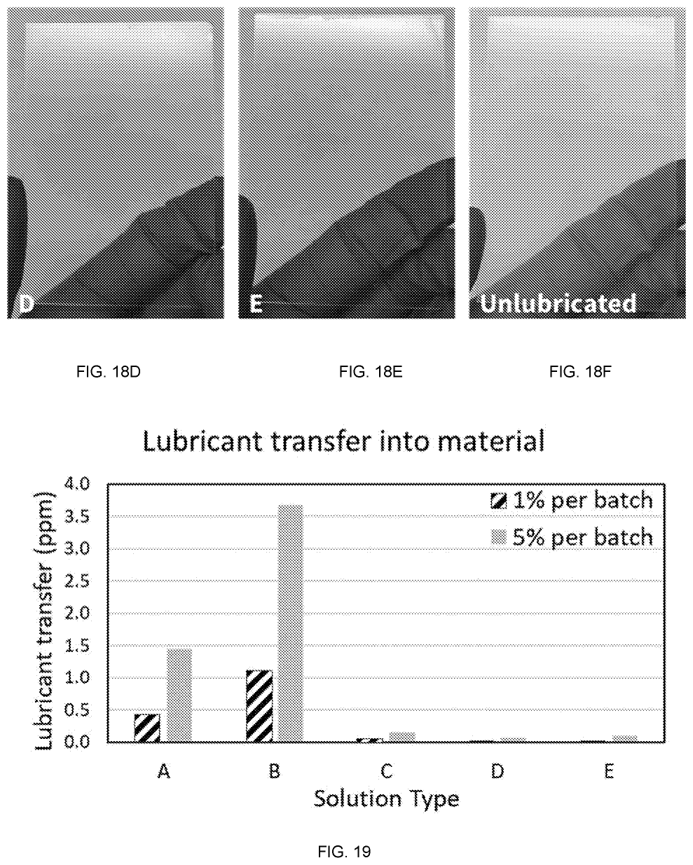

Even with the use of a multi-component system, the concentration of the liquid component is important. If the concentration is too high then there is still a chance of over lubrication and lack of controlled deposition, as shown by the sagging lubricant for FIGS. 18A-18B. However, at much lower concentrations the minimal functional amount is applied and less liquid component is used overall (FIGS. 17A-17B).

The amount of lubricant that is applied to the surface is important as this dictates the contamination level which goes into the final product. Assuming a 4000 gallon cylindrical vessel with H/D=8000 containing a batch size of 10,800kg at any given time, the lubricant transfer per cycle is calculated based on the solutions presented in Table and shown in FIG. 19. The lubricant depletion rate is assumed to be between 1-5%. For Solutions A-B, the contamination level can be almost 2 orders of magnitude greater than solutions D-E. Thus, it is important to have controlled deposition of lubricant on the surface to minimize the lubricant transfer into the final product

### Minimizing the Travel Distance of Solution During Application to Maximize Transfer Efficiency (Prophetic)

As the travel distance increases the losses of lubricant in the system also increase and this results in lower transfer efficiencies

For example is a handheld gun where the travel distance of the solution from the hopper to the outlet is around 10 cm the transfer efficiency is higher as compared to a pressure washer where the travel distance is around 25 ft

One way to improve this is to move the venturi valve closer to the handle of the pressure washer but we have not done this yet

Washing residue from surface & recharging surface with lubricant simultaneously (Prophetic)

A low concentration (0.1-1 wt %) of an alkaline or acid detergent is prepared in water. Using this solution, a 5 wt % solution of K105 is prepared by ultrasonication for 30 seconds. The resulting mixture is sprayed onto a sample that has buildup due to lubricant depletion. The detergent readily removes the buildup and at the same time the lubricant recharges the surface.

Conclusions

Three different types of lubricant compositions for long-lasting lubrication of a textured surface were demonstrated. The results show that for all the three types of lubricant compositions, varying either lubricant concentration or number of spray passes while fixing the other variable could be employed to achieve desired net transferred lubricant mass on the textured surface. For each composition, the range of lubricant concentration/number of passes needs to be optimized based on the total surface area being lubricated, surface roughness of the textured surface, evaporation rates of carrier liquids, miscibility with the lubricant, wettability on the liquids used on the textured surface, viscosities and etc. At low lubricant concentration, the deposition of lubricant on the textured surface is more controlled, can prevent over-lubrication, however requires increased number of application passes to get the desired total transferred lubricant mass.

This method can be used to replenish under-lubricated surface by spraying more lubricant using the described lubricant compositions on the textured surface until a desired level of lubrication and slipperiness is achieved (e.g. ethanol droplet slides again).

The current method can be applied for different lubricant chemistries. In this study, silicone oil (as ‘active’) was mixed in water (as ‘carrier’) and sprayed over the textured surface. Total transferred lubricant mass was reached to the desired range by this method. The same approach can be used for other types of lubricants such as hydrocarbon oil, vegetable oil, fluorohydrocarbon, fluorosilicone, etc.

It should be emphasized that the above-described embodiments of the present disclosure are merely possible examples of implementations, and are set forth only for a clear understanding of the principles of the disclosure. Many variations and modifications may be made to the above-described embodiments of the disclosure without departing substantially from the spirit and principles of the disclosure. All such modifications and variations are intended to be included herein within the scope of this disclosure.

1. A lubricant composition for lubrication of a hydrophobic textured solid surface, the composition comprising:
a) a first effective amount of a low surface tension liquid, wherein the low surface tension liquid has a positive spreading coefficient to the solid surface and a chemical affinity for the hydrophobic textured surface and a surface tension (mN/m) that is lower than a surface energy (mJ/m²) of the hydrophobic textured surface, and wherein the first effective amount is such that the low surface tension liquid spontaneously wets, spreads, and adheres to the hydrophobic textured surface when applied thereto to lubricate the hydrophobic textured solid surface; and
b) a second effective amount of a high surface tension liquid, wherein the high surface tension liquid is immiscible with the low surface tension liquid and is non-reactive with the low surface tension liquid, wherein the high surface tension liquid preferentially dewets the hydrophobic textured surface and has a negative spreading coefficient to the solid surface and has a surface tension (mN/m) that is higher than the surface energy value (mJ/m²) of the hydrophobic textured surface, and wherein the second effective amount is effective to support an emulsion of the low surface tension liquid dispersed within the high surface tension liquid.

2. The lubricant composition according to claim 1, wherein the emulsion of the low surface tension liquid dispersed within the high surface tension liquid is stable for a period of time of at least 1 hours, at least 10 hours, at least 1 day, or at least 3 days at room temperature and 1 atmosphere.

3. The lubricant composition according to claim 1, wherein the low surface tension liquid and the high surface tension liquid are further mixed by one or more of the following techniques:
a) shear force-driven such as overhead mixing, centrifugal mixing, rotor-stator mixing, static mixing, and mixing with an in-line microfluidizer;
b) atomization-driven such as spraying, aspiration, siphoning, carburation, aeration, chemical injector using Bernoulli's principle, Venturi mechanism, spring/ball mechanism; and
c) ultrasonication.

4. (canceled)

5. A multiphase lubricant composition for lubrication of a hydrophobic textured solid surface, the composition comprising:
a) a first effective amount of a high boiling liquid, wherein the high boiling liquid has a positive spreading coefficient to the solid surface and a chemical affinity for the hydrophobic textured surface, and wherein the first effective amount is such that the high boiling liquid spontaneously wets and adheres to the hydrophobic textured surface when applied thereto to lubricate the hydrophobic textured surface;
b) a second effective amount of a low boiling liquid preferentially having a positive spreading coefficient to the solid surface and chemical affinity and completely wetting to the textured surface, wherein the high boiling liquid is immiscible with and unreactive with the low boiling liquid, and wherein the second effective amount is effective to support an emulsion of the high boiling liquid dispersed within the low boiling liquid.

6. The lubricant composition according to claim 5, wherein the relative boiling points of the high boiling liquid and the low boiling liquid are such that the low boiling liquid evaporates from the hydrophobic textured surface at standard temperature and pressure at a rate such that the low boiling liquid infuses the hydrophobic textured surface to lubricate the hydrophobic textured surface.

6. The lubricant composition according to claim 5, wherein the low boiling liquid has vapor pressure greater than that of the high boiling liquid under ambient pressure and temperature.

8.-12. (canceled)

13. A lubricant composition for lubrication of a hydrophobic textured solid surface, the composition comprising:
a) a first effective amount of a high boiling liquid, wherein the high boiling liquid has a positive spreading coefficient to the solid surface and a chemical affinity for the hydrophobic textured surface, and wherein the first effective amount is such that the high boiling liquid spontaneously wets and adheres to the hydrophobic textured surface when applied thereto to lubricate the hydrophobic textured surface;
b) a low boiling liquid preferentially having a positive spreading coefficient to the solid surface and chemical affinity and completely wetting to the textured surface, wherein the high boiling liquid is miscible with and unreactive with the low boiling liquid.

14. The lubricant composition according to claim 13, wherein the relative boiling points of the high boiling liquid and the low boiling liquid are such that the low boiling liquid evaporates from the hydrophobic textured surface at standard temperature and pressure at a rate such that the low boiling liquid infuses the hydrophobic textured surface to lubricate the hydrophobic textured surface.

15. The lubricant composition according to claim 13, wherein the low boiling liquid has vapor pressure greater than that of the high boiling liquid under ambient pressure and temperature.

16.-25. (canceled)

26. A method of transferring a lubricating liquid composition substantially free of particulate matter onto a textured solid surface to form a slippery and lubricious surface, wherein a desired lubricating liquid component is selectively and substantially deposited to the textured surface by using one or more of the following mechanisms:
a) from an immiscible lubricating liquid composition in which each component has different signs of spreading coefficient to the solid surface and different surface tension values, where a preferentially wetting liquid component is deposited to the textured surface, while a preferentially non-wetting liquid component is removed
b) from an immiscible lubricating liquid composition in which both components have a positive spreading coefficient to the solid surface but each component has different boiling points, where a high boiling liquid component is deposited to the textured surface, while a low boiling liquid component is removed by heating or over time at ambient condition
c) from a miscible lubricating liquid composition in which both components have a positive spreading coefficient to the solid surface but each component has different boiling points, where a high boiling liquid component is deposited to the textured surface, while a low boiling liquid component is removed by heating or over time at ambient condition

27. The method according to claim 26, wherein the lubricating liquid composition is homogenized by a surfactant prior to be transferred to a textured surface

28. The method according to claim 26, wherein the lubricating liquid composition is homogenized by one or more of the following techniques:
a) shear force-driven such as overhead mixing, centrifugal mixing, rotor-stator mixing, static mixing, and mixing with an in-line microfluidizer
b) atomization-driven such as spraying, aspiration, siphoning, carburation, aeration, chemical injector using Bernoulli's principle, Venturi mechanism, spring/ball mechanism
c) ultrasonication

29.-34. (canceled)
